(19) United States
(12) Patent Application Publication
(10) Pub. No.: US 2026/0128823 A1
(43) Pub. Date: May 7, 2026

(54) ORTHOGONAL COVER CODE CONFIGURATION BASED ON ASSISTANCE INFORMATION

(71) Applicant: QUALCOMM Incorporated, San Diego, CA (US)

(72) Inventors: Syed Hashim Ali SHAH, San Diego, CA (US); Alberto RICO ALVARINO, San Diego, CA (US)

(21) Appl. No.: 18/940,664

(22) Filed: Nov. 7, 2024

(51) Int. Cl. H04L 5/00; H04W 72/231

(52) U.S. Cl. CPC H04L 5/0007; H04W 72/231

(57) ABSTRACT

Methods, systems, and devices for wireless communications are described. A user equipment (UE) may transmit, to a network entity, an assistance information message that indicates phase impairment information for the UE, where the phase impairment information is indicative of a change in phase over time. The network entity may select an orthogonal cover code (OCC) configuration (e.g., an OCC scheme and/or OCC factor) based on the indicated phase impairment information for the UE and may indicate the selected OCC configuration to the UE. For example, changes in phase over time at a UE may impact the performance of OCC, and thus the network entity may select an OCC configuration based on the phase impairment at the UE. The UE may perform an uplink shared channel communication using the indicated OCC configuration.

### INTRODUCTION

The following relates to wireless communications, including orthogonal cover code configurations for multiplexing transmissions by multiple communication devices.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include transmitting, for a network entity, an assistance information message that indicates phase impairment information for the UE, where the phase impairment information is indicative of a change in phase over time, receiving, in association with the network entity and based on transmission of the assistance information message, a control message that indicates an orthogonal cover code (OCC) configuration, where the OCC configuration includes an OCC scheme from a set of candidate OCC schemes, and where the OCC configuration includes an OCC factor, and transmitting, for the network entity, an uplink shared channel communication in accordance with the OCC configuration.

An apparatus for wireless communications at a UE is described. The apparatus may include one or more memories storing processor-executable code; and one or more processors coupled with the one or more memories and configured to cause the UE to transmit, for a network entity, an assistance information message that indicates phase impairment information for the UE, where the phase impairment information is indicative of a change in phase over time, receive, in association with the network entity and based on transmission of the assistance information message, a control message that indicates an OCC configuration, where the OCC configuration includes an OCC scheme from a set of candidate OCC schemes, and where the OCC configuration includes an OCC factor, and transmit, for the network entity, an uplink shared channel communication in accordance with the OCC configuration.

Another UE for wireless communications is described. The UE may include means for transmitting, for a network entity, an assistance information message that indicates phase impairment information for the UE, where the phase impairment information is indicative of a change in phase over time, means for receiving, in association with the network entity and based on transmission of the assistance information message, a control message that indicates an OCC configuration, where the OCC configuration includes an OCC scheme from a set of candidate OCC schemes, and where the OCC configuration includes an OCC factor, and means for transmitting, for the network entity, an uplink shared channel communication in accordance with the OCC configuration.

A non-transitory computer-readable medium storing code for wireless communications is described. The code may include instructions executable by one or more processors to cause a UE to transmit, for a network entity, an assistance information message that indicates phase impairment information for the UE, where the phase impairment information is indicative of a change in phase over time, receive, in association with the network entity and based on transmission of the assistance information message, a control message that indicates an OCC configuration, where the OCC configuration includes an OCC scheme from a set of candidate OCC schemes, and where the OCC configuration includes an OCC factor, and transmit, for the network entity, an uplink shared channel communication in accordance with the OCC configuration.

Some examples of the method, apparatuses, UEs and non-transitory computer-readable medium described herein may further include operations, features, means, or instructions for receiving, from the network entity, a request for the assistance information message, where transmission of the assistance information message may be based on the request.

Some examples of the method, apparatuses, UEs and non-transitory computer-readable medium described herein may further include operations, features, means, or instructions for resetting an assistance information timer based on reception of the request, where the assistance information timer may be associated with triggering transmission of the assistance information message.

In some examples of the method, apparatuses, UEs and non-transitory computer-readable medium described herein, transmission of the assistance information message may be based on an expiration of an assistance information timer associated with triggering transmission of the assistance information message.

Some examples of the method, apparatuses, UEs and non-transitory computer-readable medium described herein may further include operations, features, means, or instructions for detecting that a phase impairment condition for the UE exceeds a threshold, where transmission of the assistance information message may be based on detection that the phase impairment condition for the UE exceeds the threshold.

Some examples of the method, apparatuses, UEs and non-transitory computer-readable medium described herein may further include operations, features, means, or instructions for receiving, in association with the network entity, an assistance information transmission periodicity, where transmission of the assistance information message may be in accordance with the assistance information transmission periodicity.

In some examples of the method, apparatuses, UEs and non-transitory computer-readable medium described herein, the OCC scheme includes a slot-wise OCC scheme based on a phase impairment associated with the phase impairment information being below a threshold.

In some examples of the method, apparatuses, UEs and non-transitory computer-readable medium described herein, the OCC scheme includes a symbol-wise OCC scheme based on a phase impairment associated with the phase impairment information being above a threshold.

In some examples of the method, apparatuses, UEs and non-transitory computer-readable medium described herein, the OCC scheme includes a sub-physical resource block OCC scheme based on a phase impairment associated with the phase impairment information being above a threshold.

In some examples of the method, apparatuses, UEs and non-transitory computer-readable medium described herein, the OCC scheme includes a symbol-wise OCC scheme, a slot-wise OCC scheme, a sub-physical resource block OCC scheme, or a combination thereof.

Some examples of the method, apparatuses, UEs and non-transitory computer-readable medium described herein may further include operations, features, means, or instructions for receiving, in association with the network entity, one or more reference signals and calculating, based on the one or more reference signals, the phase impairment information.

Some examples of the method, apparatuses, UEs and non-transitory computer-readable medium described herein may further include operations, features, means, or instructions for transmitting, for the network entity after reception of the control message, a second assistance information message that indicates second phase impairment information for the UE, where the assistance information message may be a first assistance information message, where the phase impairment information may be a first phase impairment information, where the control message may be a first control message, where the OCC configuration may be a first OCC configuration, where the OCC scheme may be a first OCC scheme, where the OCC factor may be a first OCC factor, and where the second phase impairment information for the UE may be different than the first phase impairment information and receiving, in association with the network entity and based on transmission of the second assistance information message, a second control message that indicates a second OCC configuration, where the second OCC configuration includes at least one of a second OCC scheme different from the first OCC scheme or a second OCC factor different from the first OCC factor.

In some examples of the method, apparatuses, UEs and non-transitory computer-readable medium described herein, the phase impairment information may be indicative of a phase impairment error in parts per million, a slope of change in temperature of the UE over time, or a slope of change in phase over time.

In some examples of the method, apparatuses, UEs and non-transitory computer-readable medium described herein, the phase impairment information indicates a quantized state from a set of candidate quantized states and each of the set of candidate quantized states corresponds to a range of phase impairment values.

Some examples of the method, apparatuses, UEs and non-transitory computer-readable medium described herein may further include operations, features, means, or instructions for receiving, via the control message, scheduling information for the uplink shared channel communication, where transmission of the uplink shared channel communication may be in accordance with the scheduling information.

Some examples of the method, apparatuses, UEs and non-transitory computer-readable medium described herein may further include operations, features, means, or instructions for receiving a second control message that includes scheduling information for the uplink shared channel communication, where transmission of the uplink shared channel communication may be in accordance with the scheduling information.

In some examples of the method, apparatuses, UEs and non-transitory computer-readable medium described herein, the OCC configuration further includes an OCC codeword.

In some examples of the method, apparatuses, UEs and non-transitory computer-readable medium described herein, the control message may be conveyed via one of a downlink control information, radio resource control (RRC), or a medium access control (MAC) control element (MAC-CE).

A method for wireless communications by a network entity is described. The method may include obtaining an assistance information message that indicates phase impairment information for a UE, where the phase impairment information is indicative of a change in phase over time, outputting, for the UE and based on the assistance information message, a control message that indicates an OCC configuration, where the OCC configuration includes an OCC scheme from a set of candidate OCC schemes, and where the OCC configuration includes an OCC factor, and obtaining an uplink shared channel communication associated with the UE in accordance with the OCC configuration.

An apparatus for wireless communications at a network entity is described. The apparatus may include one or more memories storing processor-executable code; and one or more processors coupled with the one or more memories and configured to cause the network entity to obtain an assistance information message that indicates phase impairment information for a UE, where the phase impairment information is indicative of a change in phase over time, output, for the UE and based on the assistance information message, a control message that indicates an OCC configuration, where the OCC configuration includes an OCC scheme from a set of candidate OCC schemes, and where the OCC configuration includes an OCC factor, and obtain an uplink shared channel communication associated with the UE in accordance with the OCC configuration.

Another network entity for wireless communications is described. The network entity may include means for obtaining an assistance information message that indicates phase impairment information for a UE, where the phase impairment information is indicative of a change in phase over time, means for outputting, for the UE and based on the assistance information message, a control message that indicates an OCC configuration, where the OCC configuration includes an OCC scheme from a set of candidate OCC schemes, and where the OCC configuration includes an OCC factor, and means for obtaining an uplink shared channel communication associated with the UE in accordance with the OCC configuration.

A non-transitory computer-readable medium storing code for wireless communications is described. The code may include instructions executable by one or more processors to cause a network entity to obtain an assistance information message that indicates phase impairment information for a UE, where the phase impairment information is indicative of a change in phase over time, output, for the UE and based on the assistance information message, a control message that indicates an OCC configuration, where the OCC configuration includes an OCC scheme from a set of candidate OCC schemes, and where the OCC configuration includes an OCC factor, and obtain an uplink shared channel communication associated with the UE in accordance with the OCC configuration.

Some examples of the method, apparatuses, network entities, and non-transitory computer-readable medium described herein may further include operations, features, means, or instructions for obtaining a second assistance information message that indicates second phase impairment information for a second UE, where the second phase impairment information may be indicative of a second change in phase over time, where the assistance information message may be a first assistance information message, where the phase impairment information may be a first phase impairment information, where the UE may be a first UE, where the control message may be a first control message, where the OCC configuration may be a first OCC configuration, and where the uplink shared channel communication may be a first uplink shared channel communication, outputting, for the second UE and based on the second assistance information message, a second control message that indicates a second OCC configuration, where the second OCC configuration includes the OCC scheme, where the second OCC configuration includes the OCC factor, and obtaining, via a same set of time and frequency resources as the first uplink shared channel communication, a second uplink shared channel communication associated with the second UE in accordance with the second OCC configuration.

Some examples of the method, apparatuses, network entities, and non-transitory computer-readable medium described herein may further include operations, features, means, or instructions for outputting, for the first UE, an indication of a first OCC codeword associated with the first OCC configuration and outputting, for the second UE, an indication of a second OCC codeword associated with the second OCC configuration, where the first uplink shared channel communication may be coded in accordance with the first OCC codeword, and where the second uplink shared channel communication may be coded in accordance with the second OCC codeword.

Some examples of the method, apparatuses, network entities, and non-transitory computer-readable medium described herein may further include operations, features, means, or instructions for outputting, for the UE, a request for the assistance information message, where obtention of the assistance information message may be based on the request.

Some examples of the method, apparatuses, network entities, and non-transitory computer-readable medium described herein may further include operations, features, means, or instructions for outputting, for the UE, an assistance information transmission periodicity, where obtention of the assistance information message may be in accordance with the assistance information transmission periodicity.

In some examples of the method, apparatuses, network entities, and non-transitory computer-readable medium described herein, the OCC scheme includes a slot-wise OCC scheme based on a phase impairment associated with the phase impairment information being below a threshold.

In some examples of the method, apparatuses, network entities, and non-transitory computer-readable medium described herein, the OCC scheme includes a symbol-wise OCC scheme based on a phase impairment associated with the phase impairment information being above a threshold.

In some examples of the method, apparatuses, network entities, and non-transitory computer-readable medium described herein, the OCC scheme includes a sub-physical resource block OCC scheme based on a phase impairment associated with the phase impairment information being above a threshold.

In some examples of the method, apparatuses, network entities, and non-transitory computer-readable medium described herein, the OCC scheme includes a symbol-wise OCC scheme, a slot-wise OCC scheme, a sub-physical resource block OCC scheme, or a combination thereof.

Some examples of the method, apparatuses, network entities, and non-transitory computer-readable medium described herein may further include operations, features, means, or instructions for obtaining, in association with the UE and after output of the control message, a second assistance information message that indicates second phase impairment information for the UE, where the assistance information message may be a first assistance information message, where the phase impairment information may be a first phase impairment information, where the control message may be a first control message, where the OCC configuration may be a first OCC configuration, where the OCC scheme may be a first OCC scheme, where the OCC factor may be a first OCC factor, and where the second phase impairment information for the UE different than the first phase impairment information and outputting, for the UE and based least in part on the second assistance information message, a second control message that indicates a second OCC configuration, where the second OCC configuration includes at least one of a second OCC scheme different from the first OCC scheme or a second OCC factor different from the first OCC factor.

In some examples of the method, apparatuses, network entities, and non-transitory computer-readable medium described herein, the phase impairment information may be indicative of a phase impairment error in parts per million, a slope of change in temperature of the UE over time, or a slope of change in phase over time.

In some examples of the method, apparatuses, network entities, and non-transitory computer-readable medium described herein, the phase impairment information indicates a quantized state from a set of candidate quantized states and each of the set of candidate quantized states corresponds to a range of phase impairment values.

Some examples of the method, apparatuses, network entities, and non-transitory computer-readable medium described herein may further include operations, features, means, or instructions for outputting, via the control message, scheduling information for the uplink shared channel communication, where transmission of the uplink shared channel communication may be in accordance with the scheduling information.

Some examples of the method, apparatuses, network entities, and non-transitory computer-readable medium described herein may further include operations, features, means, or instructions for outputting, for the UE, a second control message that includes scheduling information for the uplink shared channel communication, where transmission of the uplink shared channel communication may be in accordance with the scheduling information.

In some examples of the method, apparatuses, network entities, and non-transitory computer-readable medium described herein, the OCC configuration further includes an OCC codeword.

In some examples of the method, apparatuses, network entities, and non-transitory computer-readable medium described herein, the control message may be conveyed via one of a downlink control information, RRC, or a MAC-CE.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports orthogonal cover code (OCC) configuration based on assistance information in accordance with one or more aspects of the present disclosure.

FIG. 2 shows an example of a network architecture that supports OCC configuration based on assistance information in accordance with one or more aspects of the present disclosure.

FIGS. 3A and 3B show examples of OCC encoding diagrams that support OCC configuration based on assistance information in accordance with one or more aspects of the present disclosure.

FIG. 4 shows an example of a wireless communications system that supports OCC configuration based on assistance information in accordance with one or more aspects of the present disclosure.

FIG. 5 shows an example of a process flow that supports OCC configuration based on assistance information in accordance with one or more aspects of the present disclosure.

FIGS. 6 and 7 show block diagrams of devices that support OCC configuration based on assistance information in accordance with one or more aspects of the present disclosure.

FIG. 8 shows a block diagram of a communications manager that supports OCC configuration based on assistance information in accordance with one or more aspects of the present disclosure.

FIG. 9 shows a diagram of a system including a device that supports OCC configuration based on assistance information in accordance with one or more aspects of the present disclosure.

FIGS. 10 and 11 show block diagrams of devices that support OCC configuration based on assistance information in accordance with one or more aspects of the present disclosure.

FIG. 12 shows a block diagram of a communications manager that supports OCC configuration based on assistance information in accordance with one or more aspects of the present disclosure.

FIG. 13 shows a diagram of a system including a device that supports OCC configuration based on assistance information in accordance with one or more aspects of the present disclosure.

FIGS. 14 through 16 show flowcharts illustrating methods that support OCC configuration based on assistance information in accordance with one or more aspects of the present disclosure.

### DETAILED DESCRIPTION

In some wireless communications systems, such as in a narrowband internet of things (NB-IoT) system or a New Radio (NR) non-terrestrial network (NTN) system, a user equipment (UE) may transmit multiple coded copies of data (e.g., repetitions of data). For example, a coded copy of data may be a block of data encoded using an error correcting code that enables a receiving device to detect errors in the transmission of the data block over the channel medium. In some examples, multiple copies of the data may be transmitted to increase the likelihood that the receiver successfully receives the data. In some examples, the repetitions may include multiple uplink hybrid automatic repeat request (HARQ) redundancy versions (RVs). In non-orthogonal multiple access (NOMA) schemes, the transmitting UEs may use robust scrambling schemes to transmit via the same time-frequency resources, and the receiving network entity may use a complex receiver design in order to descramble the transmissions received from the UEs via the same time-frequency resources and identify from which UE each transmission was received. In some examples, however, transmitting UEs may use an orthogonal cover code (OCC) to enable orthogonal M order UE multiplexing (e.g., multiplexing uplink transmissions from M different UEs on the same time-frequency resources) without robust scrambling by the UEs and/or complex receiver design at the network entity. For example, application of an OCC may enable the transmissions from the multiple UEs via the same time-frequency resources to be orthogonal. Use of OCC may involve application of an M length OCC codeword across repetitions of data. Thus, if the channel coding rate of the UEs is sufficiently low for a given quantity of scheduled repetitions of data (e.g., communications via an NTN link may be subject to noisy channel conditions that demand multiple repetitions), the UEs may apply the M factor OCC without increasing the amount of time-frequency resources used for the uplink transmissions. An OCC may refer to a coding scheme that enables a receiving device to distinguish multiple users (e.g., UEs) that transmit on the same time-frequency resources via application of orthogonal codewords to the transmitted data by each of the users. The network may indicate the OCC factor (e.g., M) and the OCC codeword for each UE to use.

Repetitions of uplink transmissions, and thus orthogonal cover coding, may be performed, for example, at the slot level or symbol level for NB-IoT, or at the slot level or the sub-physical resource block (PRB) level for NR NTN. For example at the slot level, the M length OCC codeword may be applied to a slot to generate M orthogonal cover coded repetitions of the slot. As another example, at the symbol level, the M length OCC codeword may be applied to a symbol to generate M orthogonal cover coded repetitions of the symbol. As another example, at the sub-PRB level, the M length OCC codeword may be applied to a sub-carrier to generate M orthogonal cover coded sub-carriers spaced apart in the frequency domain. Scheduling repetitions at the slot level may be simpler than scheduling repetitions at the symbol or sub-PRB level, as the slot level is less granular and DCI formats used for uplink scheduling may be configured for slot level scheduling. However, OCC at larger time granularities (e.g., slots as compared to symbols or sub-PRB level) may be more susceptible to phase impairment caused by carrier frequency offset (CFO). Phase impairment for an uplink transmission may refer to a shift in the phase of the uplink transmission from what is expected by the receiving network entity.

CFO may refer to the discrepancy or difference between the expected and actual received frequency in a wireless communication system. CFO may occur due to various factors such as Doppler shifts caused by the physical movement of the transmitter or receiver or inaccuracies in the oscillators used in the communication devices. For example, an increase in internal temperature at the UE may cause discrepancies in the local oscillator of the UE, which may cause CFO. CFO at a transmitting device may cause a phase shift in the received signal at the receiving device, as the transmitting device may transmit at a phase shift that is not expected by the receiving device. Accordingly, absent correction, OCC schemes which may apply codewords that shift phases to create orthogonality between users may be impacted by phase shifts caused by CFO. CFO may be calculated by a UE, and thus mitigated, based on measurements of reference signals such as demodulation reference signals (DMRSs) and/or phase tracking reference signals (PTRSs). For example, a UE may use a measurement of a reference signal transmitted by the network entity to synchronize timing with the network entity in order to mitigate CFO. The longer duration an uplink transmission is, however, the more susceptible the uplink transmission may be to CFO, as the transmission may be further in time from a time the UE was able to correct for CFO via measurement of reference signals such as DMRSs of PTRSs.

Aspects of the present disclosure relate to transmission by a UE of an assistance information message to a network entity that may indicate phase impairment information at the UE. Additionally or alternatively, the network entity may accordingly select an OCC scheme and OCC factor for the UE to use based on the indicated phase impairment condition. Phase impairment information may refer to information indicative of a change in phase at the UE over time. For example, the change in phase may occur due to CFO. In some examples, in low phase impairment scenarios, the network entity may indicate for the UE to use slot-wise OCC and/or a larger OCC factor. An OCC configuration may refer to the OCC scheme and OCC factor. The OCC scheme may refer to the granularity of the repetition over which OCC is applied (e.g., slot level, symbol level, or sub-PRB level). The OCC factor may refer to the quantity of repetitions over which OCC is applied for a given uplink transmission. In some examples, the quantity of UEs that may be multiplexed on the same time-frequency resources using OCC may be equal to or less than the OCC factor. Additionally or alternatively, in some examples, in high phase impairment scenarios, the network entity may indicate for the UE to use symbol-wise OCC for NB-IoT or sub-PRB frequency domain based OCC for NR NTN and/or a smaller spreading factor to mitigate the effect of the phase impairment on the OCC. For example, the UE may determine the phase impairment condition at the UE based on measurements of reference signals such as DMRSs or PTRSs transmitted by the network entity. Additionally or alternatively, the UE may perform a PUSCH using the OCC configuration indicated by the network entity. Additionally or alternatively, as phase impairment conditions at the UE change, the UE may report a subsequent or additional assistance information message, and the network entity may accordingly update the OCC configuration for the UE. Additionally or alternatively, in some examples, the UE may be configured to periodically report assistance information messages that indicate phase impairment information at the UE. Additionally or alternatively, in some examples, the network entity may request an assistance information message from the UE.

Aspects of the present disclosure may facilitate multiplexing of transmissions from multiple UEs on the same time-frequency resources when such transmissions include multiple repetitions, which may enable increased uplink capacity on the same time-frequency resources. For example, the transmissions may be multiplexed via the application by the UEs of OCC codewords to the repetitions. In particular, reporting of phase impairment information via assistance information, the network may schedule UEs to perform transmissions using an OCC scheme in accordance with the current phase impairment conditions at the scheduled UEs.

For example, for UEs with high phase impairment conditions, such phase impairment may impact the accuracy of the received transmissions that use OCC. Such phase impairment may be mitigated by application of a symbol-wise or sub-PRB based OCC scheme and/or reducing the OCC factor. Accordingly, indication of the phase impairment condition via assistance information may enable the network entity to select an OCC configuration to mitigate the phase impairment. Accordingly, aspects of the present disclosure may achieve more accurate transmissions that apply OCC. As another example, for UEs with low phase impairment conditions, the network may multiplex more UEs (e.g., may use a larger OCC factor) and/or may use a slot-wise OCC scheme that may simplify scheduling. Accordingly, indication of the phase impairment condition via assistance information may enable the network entity simplify scheduling and/or increase uplink capacity for UEs with low phase impairment conditions.

Aspects of the disclosure are initially described in the context of wireless communications systems. Aspects of the disclosure are further illustrated by and described with reference to encoding configurations, process flows, apparatus diagrams, system diagrams, and flowcharts that relate to OCC configuration based on assistance information.

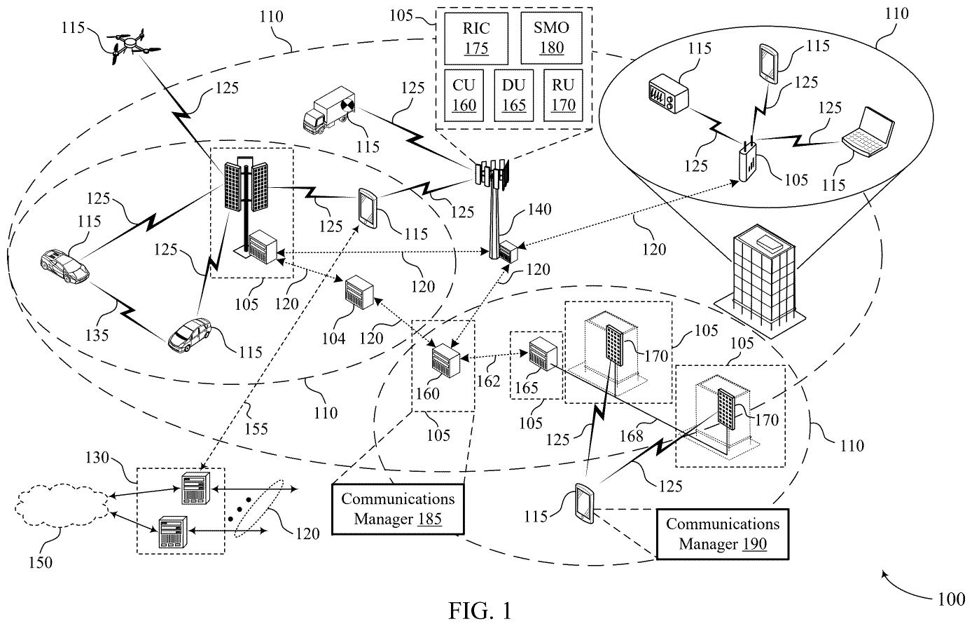

FIG. 1 shows an example of a wireless communications system 100 that supports OCC configuration based on assistance information in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

As described herein, a node, which may be referred to as a node, a network node, a network entity, or a wireless node, may be a base station (e.g., any base station described herein), a UE (e.g., any UE described herein), a network controller, an apparatus, a device, a computing system, one or more components, and/or another suitable processing entity configured to perform any of the techniques described herein. For example, a network node may be a UE. As another example, a network node may be a base station. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE being configured to receive information from a base station also discloses that a first network node being configured to receive information from a second network node, the first network node may refer to a first UE, a first base station, a first apparatus, a first device, a first computing system, a first one or more components, a first processing entity, or the like configured to receive the information; and the second network node may refer to a second UE, a second base station, a second apparatus, a second device, a second computing system, a second one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3 ), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1 ) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support OCC configuration based on assistance information as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

Techniques described herein, in addition to or as an alternative to be carried out between UEs 115 and network entities 105 (e.g., base stations), may be implemented via additional or alternative wireless devices, including IAB nodes 104, distributed units (DUs) 165, centralized units (CUs) 160, radio units (RUs) 170, and the like. For example, in some implementations, aspects described herein may be implemented in the context of a disaggregated radio access network (RAN) architecture (e.g., open RAN architecture). In a disaggregated architecture, the RAN may be split into three areas of functionality corresponding to the CU 160, the DU 165, and the RU 170. The split of functionality between the CU 160, DU 165, and RU 170 is flexible and as such gives rise to numerous permutations of different functionalities depending upon which functions (e.g., MAC functions, baseband functions, radio frequency functions, and any combinations thereof) are performed at the CU 160, DU 165, and RU 170. For example, a functional split of the protocol stack may be employed between a DU 165 and an RU 170 such that the DU 165 may support one or more layers of the protocol stack and the RU 170 may support one or more different layers of the protocol stack.

Some wireless communications systems (e.g., wireless communications system 100), infrastructure and spectral resources for NR access may additionally support wireless backhaul link capabilities in supplement to wireline backhaul connections, providing an IAB network architecture. One or more network entities 105 may include CUs 160, DUs 165, and RUs 170 and may be referred to as donor network entities 105 or IAB donors. One or more DUs 165 (e.g., and/or RUs 170) associated with a donor network entity 105 may be partially controlled by CUs 160 associated with the donor network entity 105. The one or more donor network entities 105 (e.g., IAB donors) may be in communication with one or more additional network entities 105 (e.g., IAB nodes 104) via supported access and backhaul links. IAB nodes 104 may support mobile terminal (MT) functionality controlled and/or scheduled by DUs 165 of a coupled IAB donor. In addition, the IAB nodes 104 may include DUs 165 that support communication links with additional entities (e.g., IAB nodes 104, UEs 115, etc.) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In some examples, the wireless communications system 100 may include a core network 130 (e.g., a next generation core network (NGC)), one or more IAB donors, IAB nodes 104, and UEs 115, where IAB nodes 104 may be partially controlled by each other and/or the IAB donor. The IAB donor and IAB nodes 104 may be examples of aspects of network entities 105. IAB donor and one or more IAB nodes 104 may be configured as (e.g., or in communication according to) some relay chain.

For instance, an access network (AN) or RAN may refer to communications between access nodes (e.g., IAB donor), IAB nodes 104, and one or more UEs 115. The IAB donor may facilitate connection between the core network 130 and the AN (e.g., via a wireline or wireless connection to the core network 130). That is, an IAB donor may refer to a RAN node with a wireline or wireless connection to core network 130. The IAB donor may include a CU 160 and at least one DU 165 (e.g., and RU 170), where the CU 160 may communicate with the core network 130 over an NG interface (e.g., some backhaul link). The CU 160 may host layer 3 (L3 ) (e.g., RRC, service data adaption protocol (SDAP), PDCP, etc.) functionality and signaling. The at least one DU 165 and/or RU 170 may host lower layer, such as layer 1 (L1 ) and layer 2 (L2) (e.g., RLC, MAC, physical (PHY), etc.) functionality and signaling, and may each be at least partially controlled by the CU 160. The DU 165 may support one or multiple different cells. IAB donor and IAB nodes 104 may communicate over an F1 interface according to some protocol that defines signaling messages (e.g., F1 AP protocol). Additionally, CU 160 may communicate with the core network over an NG interface (which may be an example of a portion of backhaul link), and may communicate with other CUs 160 (e.g., a CU 160 associated with an alternative IAB donor) over an Xn-C interface (which may be an example of a portion of a backhaul link).

IAB nodes 104 may refer to a RAN node that provides IAB functionality (e.g., access for UEs 115, wireless self-backhauling capabilities, etc.). IAB nodes 104 may include a DU 165 and an MT. A DU 165 may act as a distributed scheduling node towards child nodes associated with the IAB node 104, and the MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, an IAB node 104 may also be referred to as a parent node or a child node to other IAB nodes 104, depending on the relay chain or configuration of the AN. Therefore, the MT entity of IAB nodes 104 (e.g., MTs) may provide a Uu interface for a child node to receive signaling from a parent IAB node 104, and the DU interface (e.g., DUs 165) may provide a Uu interface for a parent node to signal to a child IAB node 104 or UE 115.

For example, IAB node 104 may be referred to a parent node associated with IAB node, and a child node associated with IAB donor. The IAB donor may include a CU 160 with a wireline (e.g., optical fiber) or wireless connection to the core network and may act as parent node to IAB nodes 104. For example, the DU 165 of IAB donor may relay transmissions to UEs 115 through IAB nodes 104, and may directly signal transmissions to a UE 115. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling over an NR Uu interface to MT of the IAB node 104. Communications with IAB node 104 may be scheduled by DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture (e.g., one or more IAB nodes 104 or components of IAB nodes 104) may be configured to support techniques for large round trip times in random access channel procedures as described herein. For example, some operations described as being performed by a UE 115 or a network entity 105 may additionally, or alternatively, be performed by components of the disaggregated RAN architecture (e.g., IAB nodes, DUs, CUs, etc.).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-(52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-, and/or FR5, or may be within the EHF band.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example, a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, NB-IoT, enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. HARQ feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples, the wireless communications system 100 may implement NB-IoT and/or NR. For example, in NB-IoT, a UE 115 may be an NB-IoT UE 115. As another example, in NR, a UE 115 may be an NR UE 115. A UE 115 may communicate with an NTN network entity 105 (e.g., a satellite network entity) via an NTN link. For example, a network entity 105 may be an NTN network entity 105 in either NB-IoT or NR. In some examples, such as in NB-IoT and/or NR systems, a UE 115 may transmit, via a UE communications manager 190, multiple coded copies of data (e.g., repetitions of data). For example, when communicating via an NTN link, the UE 115 may transmit coded copies of data (e.g., repetitions of data) to increase the probability of reception and/or to enable HARQ recombining at the network entity 105. The network entity 105 may configure, via a network entity communications manager 185, M UEs 115 with OCC configurations to enable M order UE multiplexing without robust scrambling and/or complex receiver design at the network entity 105. For example, the network entity 105 may indicate the OCC factor (e.g., M) and the OCC codeword for each UE 115 to use. Multiplexing multiple UEs 115 on the same time-frequency resources may create interference at the receiving network entity 105. Application of an OCC may mitigate such interference. For example, the data from the UEs 115 may be cover coded across repetitions (e.g., transport blocks over multiple slots (TBoMS) in an orthogonal manner using an OCC. The repetition of uplink transmissions in some wireless communication systems, such as when communicating via an NTN link, may enable application of OCC without increasing dedicated time-frequency resources (e.g., as compared to code division multiple access (CDMA)). For example, the different types of resource allocations of the OFDM grid structure and use of TBoMS may enable application of OCC for free with respect to additional resources (e.g., without use of additional repetitions other than what is already scheduled for increased reception probability and thus without additional time-frequency resources for uplink communications).

For example, OCC may be applied to DFT-s-OFDM physical uplink shared channel (PUSCH) transmissions for NR NTN (e.g., for FR1 NTN) to multiplex multiple PUSCH transmissions from multiple UEs 115. In NR NTN, OCC may be applied across OFDM symbols, across slots, and/or within an OFDM symbol. In some examples, OCC may not be applied to PUSCH DMRS for NR NTN. As another example, OCC may be applied to enable multiplexing of multiple UEs in NB-IoT (e.g., in NB-IoT communications via an NTN link). For example, multiple UEs 115 may be multiplexed in a single 3.75 kHz or 15 kHz subcarrier via OCC for narrowband PUSCH (NPUSCH) format 1 and/or narrowband physical random access channel (NPRACH) transmissions (e.g., RAN1 or RAN2). OCC may support multi-tone for 15 kHz subcarrier spacing.

OCC may be applied in the time domain (TD) (e.g., repetitions may occur across slots or symbols) or in the frequency domain (FD) (e.g., repetitions may occur across PRBs in the same symbol). For example, in NR via an NTN link, repetitions, and thus OCC, may be scheduled for repetition in the TD at the slot level or for repetition in the FD at the sub-PRB level. An another example, for NB-IoT via an NTN link, repetitions, and thus OCC, may be scheduled in the TD at the slot level or symbol level. Accordingly, OCC schemes may include slot-wise OCC (a TD based OCC), symbol-wise OCC (a TD based OCC) or sub-PRB OCC (e.g., an FD based OCC with a comb). In some examples, OCC schemes may include PRB wise OCC (e.g., an FD based OCC). Slot-wise OCC may be easier to implement for scheduling but may be less robust for phase impairments. Sub-PRB may be more complex to schedule (e.g., to schedule in DCI formats which may include fields for slot wise scheduling) but may be more robust to phase impairments. Phase impairments may refer to phase impairments (e.g., phase shifts at the UE 115) that vary with time. For example, CFO caused by relative movement of UEs 115 and/or oscillator error (e.g., crystal error) of the UEs 115 may cause a phase ramp in time with a slope. The slope of the phase ramp caused by CFO may be estimated using reference signals such as DMRSs and/or PTRSs. However, an increase in time away from a reference signal used to estimate the CFO may be associated with an increase in the impact of CFO. Accordingly, OCC schemes that occur over longer periods of time may be more susceptible to phase impairments. For example, slot-wise OCC may be more susceptible to phase impairments than symbol-wise OCC, and symbol-wise OCC may be more susceptible to CFO than sub-PRB OCC. Additionally, for TD based OCC, an increase in the OCC order is associated with a corresponding increase in the quantity of repetitions, and thus an increase in duration. Thus, higher order OCC may be more susceptible to phase impairments than lower order OCC.

In some examples, a UE 115 may transmit (e.g., via a UE communications manager 190), assistance information messages to a network entity 105 that may indicate phase impairment information at the UE 115. The network entity 105 may accordingly select an OCC scheme and an OCC factor for the UE 115 to use based on the indicated phase impairment condition. For example, in NR via an NTN link, the network entity 105 may select between slot-wise OCC and sub-PRB OCC. As another example, in NB-IoT or IOT via an NTN link, the network entity 105 may select between slot-wise OCC and symbol-wise OCC. The network entity 105 may transmit control signaling, via the network entity communications manager 185, to the UE 115 that indicates the selected OCC configuration (e.g., the selected OCC scheme and the selected OCC factor). The UE 115 may determine the phase impairment condition at the UE 115 based on measurements of reference signals such as DMRSs or PTRSs transmitted by the network entity 105. The UE 115 may perform, via the UE communications manager 190, a PUSCH in NR via an NTN link or an NPUSCH in NB-IoT using the OCC configuration indicated by the network entity 105. As phase impairment conditions at the UE 115 change, the UE 115 may report, via the UE communications manager 190, a subsequent or additional assistance information message, and the network entity 105 may accordingly update, via the network entity communications manager 185, the OCC configuration for the UE 115.

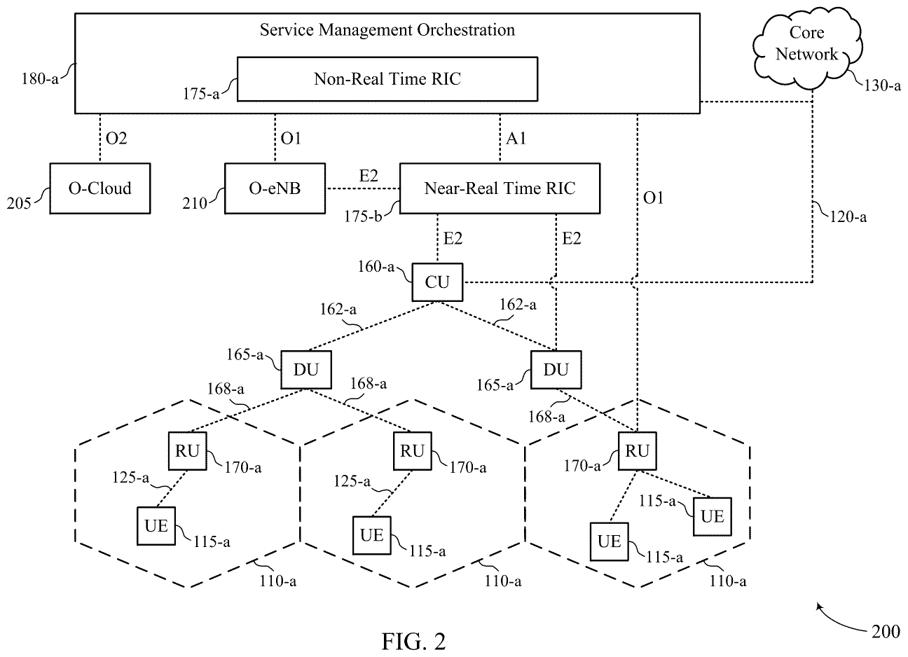

FIG. 2 shows an example of a network architecture 200 (e.g., a disaggregated base station architecture, a disaggregated RAN architecture) that supports OCC configuration based on assistance information in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via O1) or via generation of RAN management policies (e.g., A1 policies).

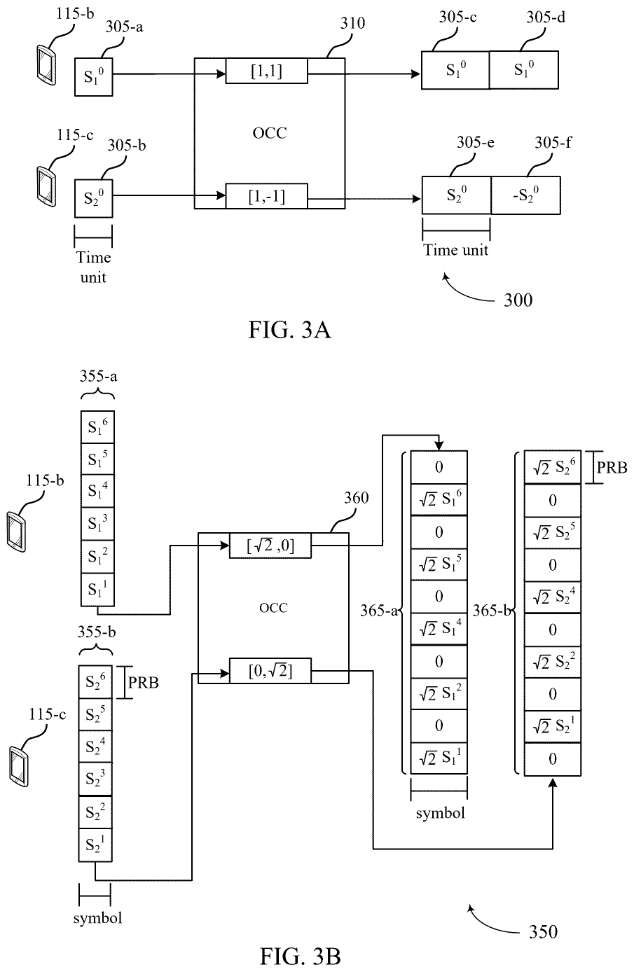

FIG. 3A shows an example of an OCC encoding diagram 300 that supports OCC configuration based on assistance information in accordance with one or more aspects of the present disclosure. FIG. 3B shows an example of an OCC encoding diagram 350 that supports OCC configuration based on assistance information in accordance with one or more aspects of the present disclosure The OCC encoding diagram 300 and the OCC encoding diagram 350 may implement or may be implemented by aspects of the wireless communications system 100. For example, the OCC encoding diagram 300 and the OCC encoding diagram 350 may include a UE 115-b and a UE 115-c, which may be examples of UE 115 as described herein.

As described herein, PUSCH transmissions and/or NPUSCH transmissions from multiple UEs may be multiplexed with OCC without sacrificing resource efficiency due to repetition. For example, multiple UEs may transmit PUSCH or NPUSCH with OCC on a same time-frequency resource with minimal performance degradation, and each UE may achieve coverage enhancement from repetition. The OCC encoding diagram 300 shows application of a cover code in the TD. For example, a time unit over which an OCC may be applied may be a symbol or a slot. OCC may be applied to generate orthogonal transmissions for the UE 115-b and the UE 115-c as described herein.

In the encoding configuration shown in the OCC encoding diagram 300, the UE 115-b may input a first encoded data time unit 305-a (e.g., an encoded slot or an encoded symbol) to an OCC matrix 310 and the UE 115-c may input a second encoded data time unit 305-b to the OCC matrix 310. The OCC matrix 310 may be a 2×2 matrix (e.g., two rows and two columns). For example, the OCC matrix 310 may be a Hadamard matrix, an identity matrix, or a DFT matrix. In OCC, each row or column of the OCC matrix 310 may be used as a codeword. To be compatible with OCC, each row or column of a matrix may be orthogonal.

For example, for the OCC matrix 310, the first row may correspond to a vector [1,1] that, when given as an input the first encoded data time unit 305-a, outputs a product including a third encoded data time unit 305-c and a fourth encoded data time unit 305-d. The third encoded data time unit 305-c and the fourth encoded data time unit 305-d may have the same values as the input of the first encoded data time unit 305-a since the vector is [1,1]. The second row of the matrix may correspond to a vector of [1,−1]. The second row, when given as an input the second encoded data time unit 305-b, outputs a product including a fifth encoded data time unit 305-e and a sixth encoded data time unit 305-f. The sixth encoded data time unit 305-f is a negative output of the input since a negative integer is applied in the vector of the matrix (e.g., the applied vector is [1,−1]). Applying the matrix in this manner to the input time units (e.g., encoded symbols or encoded slots), produces orthogonal outputs, and accordingly, transmissions from the UE 115-b and the UE 115-c are orthogonal and therefore do not interfere with each other. The encoding using the OCC matrix 310 may be applied to a set of time units for each UE (e.g., time unit

$${S}_{k}^{i} ,$$

in which the data time is k at UE i).

In some examples, for four UEs 115, the matrix may be a 4×4 Hadamard matrix having four rows and four columns. In such examples, the matrix may include a first row vector of [1, 1, 1, 1], a second row vector of [1, −1, 1, −1], a third row vector [1, 1, −1, −1], and a fourth row vector [1, −1, −1, 1]. As described herein, although an OCC matrix 310 with row vectors [1,1] and [1,−1] is used as an example for multiplexing two UEs 115 and an OCC matrix with row vectors of [1, 1, 1, 1], [1, −1, 1, −1], [1, 1, −1, −1], and [1, −1, −1, 1] is used as an example for multiplexing four UEs 115, any orthogonal matrix may be used as an OCC matrix for multiplexing UEs 115. For example, any orthogonal 2×2 matrix may be used to multiplex two UEs 115 in OCC, any orthogonal 3×3 matrix may be used to multiplex three UEs 115 in OCC, any orthogonal 4×4 matrix may be used to multiplex four UEs 115 in OCC, and so on.

Accordingly, the OCC encoding diagram 300 may be used to implement TD symbol-wise OCC (where the time unit is a symbol) or TD slot wise OCC (where the time unit is a slot).

The OCC encoding diagram 350 may be used to implement FD sub-PRB level OCC with a comb. For example, for two UEs (e.g., the UE 115-b and the UE 115-c), the UE 115-b may input a set of encoded sub-carriers 355-a (e.g., a sub-carriers

$${S}_{1}^{6} , {S}_{1}^{5} , {S}_{1}^{4} , {S}_{1}^{3} , {S}_{1}^{2} , {S}_{1}^{1} )$$

to the OCC matrix 360 to output a comb 365-a of sub-carriers. For example, as shown, the OCC matrix 360 may be an identity matrix scaled by \sqrt{M} where M is the OCC factor. As described herein, however, any orthogonal matrix may be used for OCC. A PRB may include twelve subcarriers. The first row of the OCC matrix 360 may correspond to a vector of [\sqrt{2},0], and thus the comb 365-a may include each of the encoded subcarriers multiplied by \sqrt{2} and spaced by an empty sub-carrier. The UE 115-c may input a set of encoded sub-carriers 355-b (e.g., sub-carriers

$${S}_{2}^{6} , {S}_{2}^{5} , {S}_{2}^{4} , {S}_{2}^{3} , {S}_{2}^{2} , {S}_{2}^{1} )$$

to the OCC matrix 360 to output a comb 365-b of sub-carriers. The second row of the OCC matrix 360 may correspond to a vector of [0,\sqrt{2}], and thus the comb 365-b may include each of the encoded sub-carriers multiplied by \sqrt{2} and spaced by an empty sub-carrier. Based on the application of the OCC matrix 360 to the set of encoded sub-carriers 355-a and the set of encoded sub-carriers 355-b, the empty sub-carriers of the comb 365-a may correspond to the encoded sub-carriers of the comb 365-b, and the empty sub-carriers of the comb 365-b may correspond to the encoded sub-carriers of the comb 365-a. Accordingly, the transmissions of the comb 365-a and the comb 365-b by the UE 115-b and the UE 115-c in the same time-frequency resources (e.g., over the same set of PRBs) may be orthogonal.

Although shown as sub-PRB level OCC, in some examples, OCC may be performed at the PRB level. For example, for multiplexing two UEs using OCC, application of the OCC codeword may result in one filled PRB and one empty PRB per UE 115. For example, at the PRB level, application of the OCC matrix 310 across PRBs may result in a vector \sqrt{2}*[1 1 1 1 1 1 1 1 1 1 1 1 0 0 0 0 0 0 0 0 0 0 0 0] being applied for the UE 115-b and a vector \sqrt{2}*[0 0 0 0 0 0 1 1 1 1 1 1 1] being applied for the UE 115-c (e.g., the UE 115-b may occupy a first PRB and the UE 115-c may occupy a second PRB).

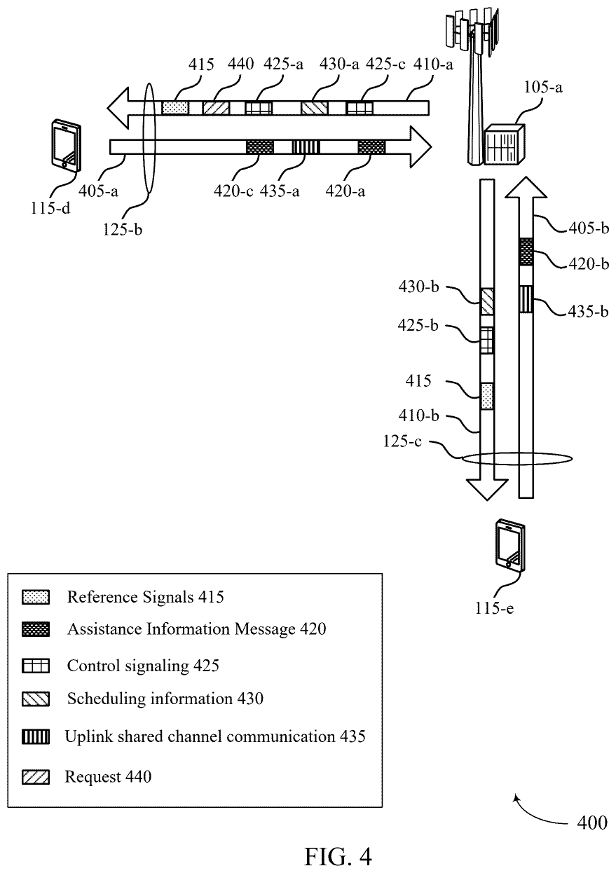

FIG. 4 shows an example of a wireless communications system 400 that supports OCC configuration based on assistance information in accordance with one or more aspects of the present disclosure. The wireless communications system 400 may implement aspects of or may be implemented by aspects of the wireless communications system 100. For example, the wireless communications system 400 includes a UE 115-d and a UE 115-e, which may be examples of a UE 115 described with respect to FIG. 1. The wireless communications system 400 also includes a network entity 105-a, which may be an example of a network entity 105 as described with respect to FIG. 1.

The UE 115-d may communicate with the network entity 105-a using a communication link 125-b, and the UE 115-e may communicate with the network entity 105-a using a communication link 125-c. The communication link 125-b may be an example of an NR or LTE link between the UE 115-d and the network entity 105-a. The communication link 125-c may be an example of an NR or LTE link between the UE 115-e and the network entity 105-b. In some examples, the communication link 125-b and/or the communication link 125-c may be examples of an NTN link. The communication link 125-b and the communication link 125-c may include bi-directional links that enable both uplink and downlink communications. For example, the UE 115-d may transmit the uplink signals 405-a (e.g., uplink transmissions), such as uplink control signals or uplink data signals, to the network entity 105-a using the communication link 125-b and the network entity 105-a may transmit downlink signals 410-a (e.g., downlink transmissions), such as downlink control signals or downlink data signals, to the UE 115-d using the communication link 125-b. The UE 115-e may transmit uplink signals 405-b (e.g., uplink transmissions), such as uplink control signals or uplink data signals, to the network entity 105-a using the communication link 125-c and the network entity 105-a may transmit downlink signals 410-b (e.g., downlink transmissions), such as downlink control signals or downlink data signals, to the UE 115-e using the communication link 125-c.

The UE 115-d may transmit an assistance information message 420-a to the network entity 105-a that indicates phase impairment information at the UE 115-d. For example, the UE 115-d may detect phase impairment information based on measurements of reference signals 415 received from the network entity 105-a. In some examples, the assistance information message 420-a may be carried in a MAC control element (MAC-CE) or RRC signaling. In some examples, the UE 115-d may periodically transmit assistance information messages 420 (for example, the UE 115-d may transmit a subsequent assistance information message 420-c). The phase impairment information in the assistance information message 420-a may assist the network entity 105-a in selecting the OCC configuration to assign to the UE 115-d.

For example, the network entity 105-a may transmit control signaling 425-a to the UE 115-d that indicates an OCC configuration based on the phase impairment information in the assistance information message 420-a. In some examples, the OCC configuration may be indicated in an RRC message, a MAC-CE, or DCI (e.g., the control signaling 425-a may be an RRC message, a MAC-CE, or DCI). The OCC configuration may indicate at least the OCC scheme (e.g., whether to use slot level OCC, symbol level OCC, or sub-PRB level OCC). In some examples, the OCC configuration may also indicate the OCC factor and/or the OCC codeword. The network entity 105-a may transmit scheduling information 430-a for an uplink shared channel communication 435-a (e.g., a PUSCH or an NPUSCH). In some examples, the scheduling information 430-a may be conveyed in the same control message as the control signaling 425-a (e.g., a DCI may indicate the OCC configuration and may schedule an uplink shared channel communication). In some examples, the scheduling information 430-a may be conveyed in a different control message than the control signaling 425-a. For example, a DCI may convey the scheduling information 430-a and an RRC message or MAC-CE may convey the control signaling 425-a that indicates the OCC configuration. In some examples, where the OCC configuration does not include the OCC codeword (e.g., the row of the orthogonal matrix to apply), the scheduling information 430-a may indicate the OCC codeword to apply. The UE 115-d may perform the uplink shared channel communication 435-a in accordance with the OCC configuration indicated in the control signaling 425-a. In some examples, the network entity 105-a may transmit subsequent control signaling 425-c than indicates an updated OCC configuration based on the subsequent assistance information message 420-c (e.g., based on a change in the phase impairment information as indicated in the subsequent assistance information message 420-c). For example, the network entity 105-a may change the OCC configuration for the UE 115-d via a MAC-CE or RRC.

The UE 115-e similarly may transmit an assistance information message 420-b that indicates phase impairment information at the UE 115-e. For example, the UE 115-e may detect phase impairment information based on measurements of reference signals 415 received from the network entity 105-a. In some examples, the assistance information message 420-b may be carried in a MAC-CE or RRC signaling. The phase impairment information in the assistance information message 420-b may assist the network entity 105-a in selecting the OCC configuration to assign to the UE 115-e. For example, the network entity 105-a may select the same OCC scheme and OCC factor for the UE 115-d and the UE 115-e. For example, the network entity 105-a may transmit control signaling 425-b to the UE 115-e that indicates an OCC configuration based on the phase impairment information in the assistance information message 420-b. The network entity 105-a may transmit scheduling information 430-b for an uplink shared channel communication 435-b (e.g., a PUSCH or an NPUSCH) in the same time-frequency resources as the uplink shared channel communication 435-a. The UE 115-e may perform the uplink shared channel communication 435-b in accordance with the OCC configuration indicated in the control signaling 425-b. Accordingly, OCC may be applied to multiplex the uplink shared channel communication 435-a and the uplink shared channel communication 435-b. In some examples, uplink shared channel communications 435 from more than two UEs 115 may be multiplexed over the same time-frequency resources. In such cases, the OCC factor may be equal to or greater than the quantity of multiplexed UEs 115 (e.g., the quantity of multiplexed uplink shared channel communications over the same time-frequency resources).

As described herein, an assistance information message 420 that includes phase impairment information may be sent via a MAC-CE or RRC. In some examples, new fields may be introduced to RRC or MAC-CE to convey an assistance information message 420. For example, in the case of a MAC-CE, new entries (e.g., indices and logical channel identifier (LCID) values) may be introduced to indicate the assistance information message 420. As another example, in the case of RRC, a new RRC field named OCCAssistanceInfo may be introduced to indicate the assistance information message 420.

As described herein, the network entity 105-a may transmit control signaling 425 that indicates an OCC configuration to the respective UE after reception of an OCC information message. For example, the control signaling 425 may be conveyed via a MAC-CE, RRC, or DCI. In some examples, new fields may be introduced to RRC, MAC-CE, or DCI to convey the control signaling that indicates the OCC configuration. For example, in the case of a MAC-CE, new entries (e.g., indices and logical channel identifier (LCID) values) maybe introduced to indicate the OCC configuration. As another example, in the case of RRC, a new RRC field named OCCConfig may be introduced to indicate the OCC configuration. As another example, in the case of DCI, a new DCI format may be introduced to convey an indication of an OCC configuration, or an OCC configuration may be indicated implicitly in an existing DCI format (e.g., based on whether the DCI schedules slot level, symbol level, or sub-PRB level repetition).

In some examples, the network entity 105-a may request an assistance information message 420 on demand. For example, the network entity 105-a may transmit a request 440 to the UE 115-d for OCC assistance information, and the UE 115-d may transmit the assistance information message 420-a in response to the request 440. In some examples, a UE 115-d may be configured with a timer for transmission of assistance information messages 420. For example, transmission of assistance information messages 420 may increase resource overhead, and thus a timer may be implemented to limit the frequency of transmission of assistance information messages 420. For example, after sending an assistance information message 420, the UE 115-d may start a timer. While the timer is running, if the UE 115-d receives a request 440 for an assistance information message, the UE 115-d may reset the timer. If the UE 115-d does not receive a request while the timer is running, the UE 115-d may wait for the timer to expire, which may trigger transmission of an assistance information message.

In some examples, transmission of assistance information messages 420 may be periodic. For example, the network entity 105-a and the UEs 115 may coordinate to configure a periodicity associated with assistance information messages, and the UEs 115 may send assistance information messages in accordance with the assigned periodicities for the UEs 115. For example, the network entity 105 may transmit control signaling to the UE 115-d that indicates an assistance information message periodicity, and the UE 115-d may transmit the assistance information messages 420 (e.g., the assistance information message 420-a and the subsequent assistance information message 420-c) in accordance with the assigned periodicity. For example, the periodicity may be assigned to a particular UE 115 based on the environment of the UE 115 (e.g., based on the UE temperature or speed of movement of the UE 115).

In some examples, transmission of assistance information messages 420 may be trigger based. For example, when the phase impairment of a UE exceeds a threshold (e.g., which may be standardized/predefined or configured by the network entity 105 such as via RRC), the UE 115 may transmit an assistance information message 420. For example, there may be multiple configured threshold that correspond to different states (e.g., which may trigger different OCC schemes or OCC factors).

As described herein, in some examples, the assistance information messages 420 may carry values of phase impairments measured by the UEs 115. Such phase impairments may be measured by the UEs 115 based on reference signals 415 such as DMRSs or PTRSs. In some examples, the unit of phase impairment may be crystal error (e.g., in parts per million (ppm)) of the local oscillator of the UEs. In some examples, the unit of phase impairment may be the slope of change in temperature over time (degrees Celsius per second, degrees Kelvin per second, or degrees Fahrenheit per second) as the change in temperature of the UE 115 may affect the local oscillator of the UE 115. For example, an increase in temperature may cause a shift in the frequency of the local oscillator. In some examples, the unit of phase impairment may be the slope of the change in phase over time (e.g., in radians per second). The constant change in phase over time (with a slope) may impact performance of OCC, as a constant phase may not impact OCC performance. Accordingly, the assistance information messages 420 may be indicate of a change in phase over time.

The phase impairment values indicated in the assistance information messages 420 may be quantized based on the quantity of bits allocated to the assistance information messages and a maximum phase impairment tolerance allowed. For example, if a maximum ±0.1 ppm phase impairment is a requirement for UEs, a ±0.1 ppm range may be quantized based on the quantity of bits available. As another example, the phase impairment values indicated in the assistance information messages 420 may be quantized based on states, which may reduce the quantity of bits to indicate the phase impairment information. For example, a state A may correspond to impairment values between ±0.03 ppm, a state B may correspond to values between ±0.03 and ±0.06 ppm, and a state C may correspond to values greater/lesser than ±0.06 ppm. Such thresholds may be predefined/standardized or signaled by the network entity 105-a to the UEs 115 (e.g., in RRC signaling or a MAC-CE). As described herein, the network entity 105-a may select an OCC configuration for a particular UE 115 based on the values/states indicated in the assistance information message 420 received from the particular UE 115.

For example, the assistance information message 420-a may convey phase impairment information for the UE 115-d, where the phase impairment information may be a clock error in ppm or a temperature of the UE 115-d (e.g., temperature may directly be proportional to clock error+phase noise). In some examples, the UE 115-d may be in a condition where the phase impairment is above a threshold (e.g., phase impairment values>x ppm where x may be configured by the network or predefined/standardized) or a state of severe phase variation over time. The UE 115-d may indicate such phase impairment information to the network entity 105-a via the assistance information message 420-a. In such cases, the network entity 105-a may select a sub-PRB or symbol level OCC scheme as such schemes are more robust to phase impairments than a slot level OCC scheme. Accordingly, the control signaling 425-a may indicate the selected OCC scheme (sub-PRB or symbol level OCC scheme) and potentially may indicate an OCC factor and/or OCC codeword for the UE 115-d (e.g., where the control signaling 425-a may be carried via DCI, a MAC-CE, or an RRC message). The UE 115-d may use the parameters set by the network entity 105-a in the control signaling 425 to transmit the uplink shared channel communication 435-a with OCC.

As another example, the UE 115-d may be in a condition where the phase impairment is at or below a threshold (e.g., phase impairment values ≤x ppm where x may be configured by the network or predefined/standardized) or a state of little phase variation over time. The UE 115-d may indicate such phase impairment information to the network entity 105-a via the assistance information message 420-a. In such cases, the network entity 105-a may select a slot level OCC scheme, as slot level OCC may be simpler to schedule than symbol level OCC or sub-PRB level OCC. Accordingly, the control signaling 425-a may indicate the selected OCC scheme (slot level OCC scheme) and potentially may indicate an OCC factor and/or OCC codeword for the UE 115-d (e.g., where the control signaling 425-a may be carried via DCI, a MAC-CE, or an RRC message). For example, the network entity 105-a may select an OCC factor based on the phase impairment information, as higher OCC factors may undergo more performance degradation from phase impairments (e.g., as higher OCC factors involve more repetitions and thus longer transmission durations). The UE 115-d may use the parameters set by the network entity 105-a in the control signaling 425 to transmit the uplink shared channel communication 435-a with OCC.

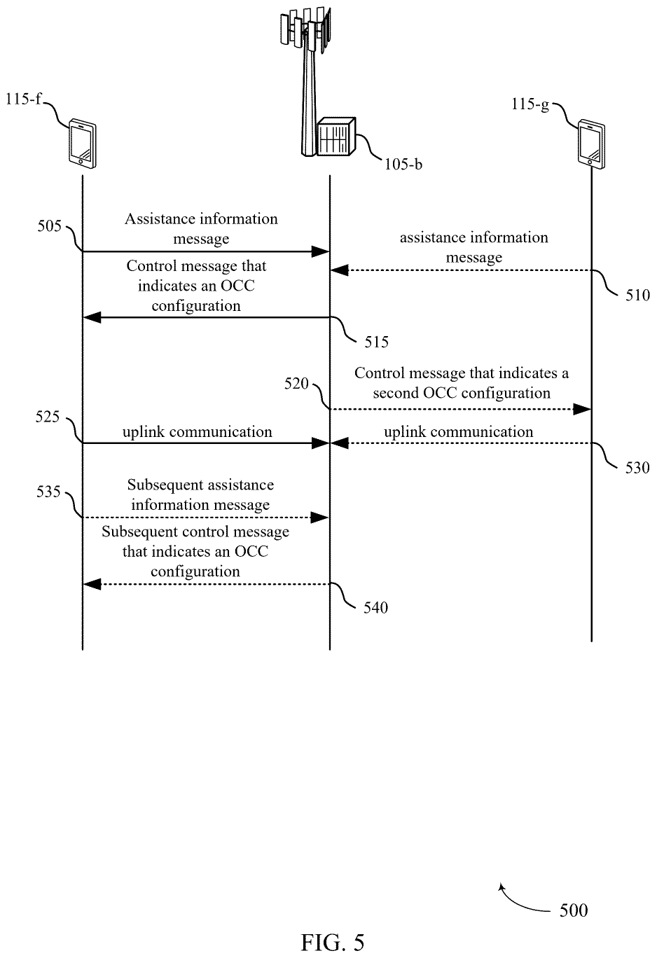

FIG. 5 shows an example of a process flow 500 that supports OCC configuration based on assistance information in accordance with one or more aspects of the present disclosure. The process flow 500 may involve two or more UEs 115, such as UE 115-f and UE 115-g, which may be examples of UEs 115, as described herein. The process flow 500 may also involve a network entity 105-b, which may be an example of network entity 105, as described with respect to FIG. 1.

In some examples, the operations illustrated in process flow 500 may be performed by hardware (e.g., including circuitry, processing blocks, logic components, and other components), code (e.g., software or firmware) executed by a processor, or any combination thereof. Alternative examples of the following may be implemented, where some steps are performed in a different order than described or are not performed at all. In some cases, steps may include additional features not mentioned below, or further steps may be added.

At 505, the UE 115-f may transmit, to the network entity 105-b, an assistance information message that indicates phase impairment information for the UE 115-f. The phase impairment information may be indicative of a change in phase over time at the UE 115-f (e.g., a change in phase of uplink transmissions by the UE 115-f over time).

In some examples, the phase impairment information may be indicative of a phase impairment error in parts per million, a slope of change in temperature of the UE 115-f over time, or a slope of change in phase over time. In some examples, the phase impairment information indicates a quantized state from a set of candidate quantized states, and each of the set of candidate quantized states corresponds to a range of phase impairment values.

At 515, the UE 115-f may receive, from the network entity 105-b and based on transmission of the assistance information message at 505, a control message that indicates an OCC configuration. The OCC configuration may include an OCC scheme from a set of candidate OCC schemes. For example, the candidate OCC schemes may include a symbol-wise OCC scheme, a slot-wise OCC scheme, or a sub-PRB OCC scheme, or a combination thereof. The OCC configuration may include an OCC factor.

At 525, the UE 115-f may transmit, to the network entity 105-b, an uplink shared channel communication in accordance with the OCC configuration indicated at 515.

In some examples, at 510, the UE 115-g may transmit, to the network entity 105-b, a second assistance information message that indicates second phase impairment information for the UE 115-g. The second phase impairment information may be indicative of a change in phase over time at the UE 115-g. In some examples, at 520, the UE 115-g may receive, from the network entity 105-b and based on transmission of the second assistance information message at 510, a second control message that indicates a second OCC configuration. The second OCC configuration may include the same OCC and the same OCC factor as the OCC configuration indicated to the UE 115-f at 515. In some examples, at 530, the UE 115-g may transmit, to the network entity 105-b, a second uplink shared channel communication in accordance with the second OCC configuration and via a same set of time and frequency resources as the uplink shared channel communication at 525. In some examples, the network entity 105-b may transmit, to the UE 115-f, an indication of a first OCC codeword associated with the first OCC configuration. The network entity 105-b may transmit, to the UE 115-g, an indication of a second OCC codeword associated with the second OCC configuration. The uplink shared channel communication at 525 may be coded in accordance with the first OCC codeword, and the second uplink shared channel communication at 530 may be coded in accordance with the second OCC codeword.

In some examples, the UE 115-f may receive, from the network entity 105-b, a request for the assistance information message, and transmission of the assistance information message at 505 may be based on the request. In some examples, the UE 115-f may reset an assistance information timer based on reception of the request, where the assistance information timer is associated with triggering of transmission of assistance information messages.

In some examples, the UE 115-f may detect that a phase impairment condition for the UE 115-f exceeds a threshold, and transmission of the assistance information message at 505 may be based on detection that the phase impairment condition for the UE 115-f exceeds the threshold.

In some examples, the UE 115-f may receive, from the network entity 105-b, an assistance information transmission periodicity, and transmission of the assistance information message at 505 may be in accordance with the assistance information transmission periodicity.

In some examples, the OCC scheme may be a slot-wise OCC scheme based on a phase impairment associated with the phase impairment information being below a threshold. For example, the threshold may be standardized/predefined or configured by the network entity 105-a.

In some examples, the OCC scheme may be a symbol-wise OCC scheme based on a phase impairment associated with the phase impairment information being above a threshold. For example, the threshold may be standardized/predefined or configured by the network entity 105-a.

In some examples, the OCC scheme may be a sub-PRB OCC scheme based on a phase impairment associated with the phase impairment information being above a threshold. For example, the threshold may be standardized/predefined or configured by the network entity 105-a.

In some examples, the OCC scheme may be a symbol-wise OCC scheme, a slot-wise OCC scheme, or a sub-PRB OCC scheme, or a combination thereof (e.g., the candidate cover code schemes may include a symbol-wise OCC scheme, a slot-wise OCC scheme, or a sub-PRB OCC scheme, or a combination thereof).

In some examples, the UE 115-f may receive, from the network entity 105-b, one or more reference signals (e.g., DMRSs or PTRSs). The UE 115-f may calculate the phase impairment information based on the reference signals.

In some examples, at 535 the UE 115-f may transmit, to the network entity 105-b and after reception of the control message at 515, a second assistance information message that indicates second phase impairment information for the UE 115-f. The second phase impairment information for the UE 115-f may be different than the first phase impairment information. In some such examples, at 540, the UE 115-f may receive, from the network entity 105-b and based on transmission of the second assistance information message, a second control message that indicates a second OCC configuration. The second OCC configuration may include at least one of a second OCC scheme different from the OCC scheme indicated in the control message at 515 or a second OCC factor different from the OCC factor indicated in the control message at 515.

In some examples, the UE 115-f may receive, via the control message at 515, scheduling information for the uplink shared channel communication, and transmission of the uplink shared channel communication is in accordance with the scheduling information.

In some examples, the UE 115-f may receive, from the network entity 105-b, a second control message that includes scheduling information for the uplink shared channel communication, and transmission of the uplink shared channel communication is in accordance with the scheduling information.

In some examples, the OCC configuration may include an OCC codeword.

In some examples, the control message is at 515 may be conveyed via one of a DCI, RRC, or a MAC-CE.

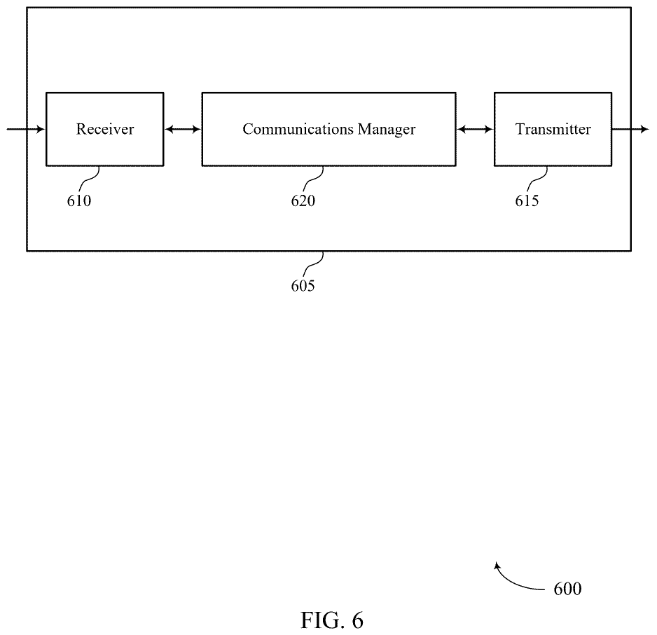

FIG. 6 shows a block diagram 600 of a device 605 that supports OCC configuration based on assistance information in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to OCC configuration based on assistance information). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to OCC configuration based on assistance information). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of OCC configuration based on assistance information as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for transmitting, for a network entity, an assistance information message that indicates phase impairment information for the UE, where the phase impairment information is indicative of a change in phase over time. The communications manager 620 is capable of, configured to, or operable to support a means for receiving, in association with the network entity and based on transmission of the assistance information message, a control message that indicates an OCC configuration, where the OCC configuration includes an OCC scheme from a set of candidate OCC schemes, and where the OCC configuration includes an OCC factor. The communications manager 620 is capable of, configured to, or operable to support a means for transmitting, for the network entity, an uplink shared channel communication in accordance with the OCC configuration.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for more efficient utilization of communication resources.

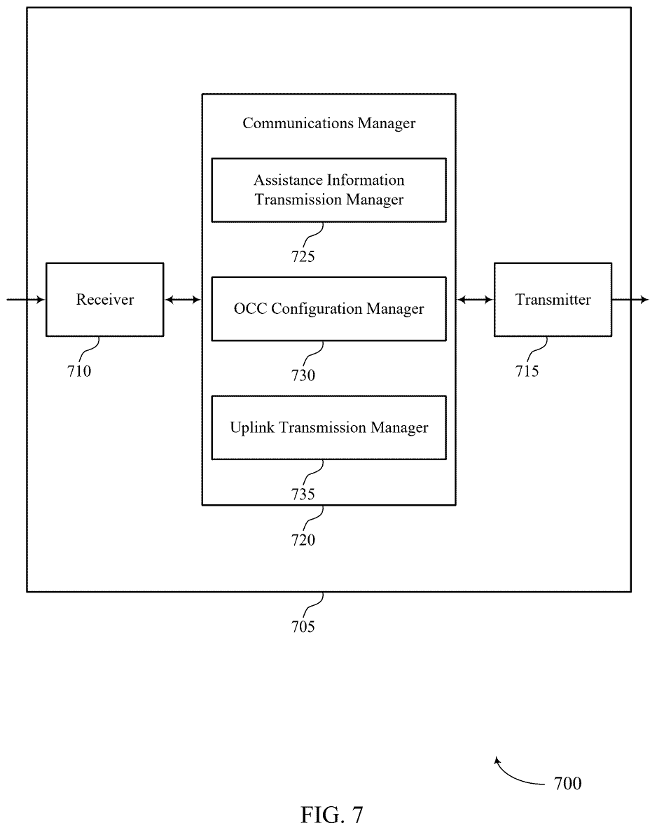

FIG. 7 shows a block diagram 700 of a device 705 that supports OCC configuration based on assistance information in accordance with one or more aspects of the present disclosure. The device 705 may be an example of aspects of a device 605 or a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to OCC configuration based on assistance information). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to OCC configuration based on assistance information). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of OCC configuration based on assistance information as described herein. For example, the communications manager 720 may include an assistance information transmission manager 725, a OCC configuration manager 730, an uplink transmission manager 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting, resetting, detecting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The assistance information transmission manager 725 is capable of, configured to, or operable to support a means for transmitting, for a network entity, an assistance information message that indicates phase impairment information for the UE, where the phase impairment information is indicative of a change in phase over time. The OCC configuration manager 730 is capable of, configured to, or operable to support a means for receiving, in association with the network entity and based on transmission of the assistance information message, a control message that indicates an OCC configuration, where the OCC configuration includes an OCC scheme from a set of candidate OCC schemes, and where the OCC configuration includes an OCC factor. The uplink transmission manager 735 is capable of, configured to, or operable to support a means for transmitting, for the network entity, an uplink shared channel communication in accordance with the OCC configuration.

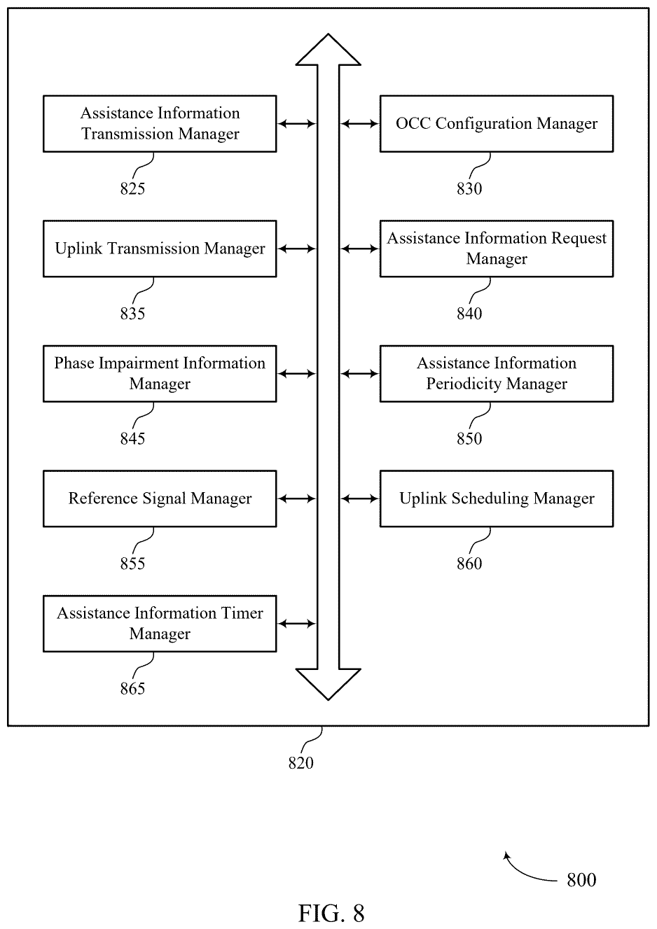

FIG. 8 shows a block diagram 800 of a communications manager 820 that supports OCC configuration based on assistance information in accordance with one or more aspects of the present disclosure. The communications manager 820 may be an example of aspects of a communications manager 620, a communications manager 720, or both, as described herein. The communications manager 820, or various components thereof, may be an example of means for performing various aspects of OCC configuration based on assistance information as described herein. For example, the communications manager 820 may include an assistance information transmission manager 825, a OCC configuration manager 830, an uplink transmission manager 835, an assistance information request manager 840, a phase impairment information manager 845, an assistance information periodicity manager 850, a reference signal manager 855, an uplink scheduling manager 860, an assistance information timer manager 865, or any combination thereof. Each of these components, or components or subcomponents thereof (e.g., one or more processors, one or more memories), may communicate, directly or indirectly, with one another (e.g., via one or more buses).

The communications manager 820 may support wireless communications in accordance with examples as disclosed herein. The assistance information transmission manager 825 is capable of, configured to, or operable to support a means for transmitting, for a network entity, an assistance information message that indicates phase impairment information for the UE, where the phase impairment information is indicative of a change in phase over time. The OCC configuration manager 830 is capable of, configured to, or operable to support a means for receiving, in association with the network entity and based on transmission of the assistance information message, a control message that indicates an OCC configuration, where the OCC configuration includes an OCC scheme from a set of candidate OCC schemes, and where the OCC configuration includes an OCC factor. The uplink transmission manager 835 is capable of, configured to, or operable to support a means for transmitting, for the network entity, an uplink shared channel communication in accordance with the OCC configuration.

In some examples, the assistance information request manager 840 is capable of, configured to, or operable to support a means for receiving, from the network entity, a request for the assistance information message, where transmission of the assistance information message is based on the request.

In some examples, the assistance information timer manager 865 is capable of, configured to, or operable to support a means for resetting an assistance information timer based on reception of the request, where the assistance information timer is associated with triggering transmission of the assistance information message.

In some examples, transmission of the assistance information message is based on an expiration of an assistance information timer associated with triggering transmission of the assistance information message.

In some examples, the phase impairment information manager 845 is capable of, configured to, or operable to support a means for detecting that a phase impairment condition for the UE exceeds a threshold, where transmission of the assistance information message is based on detection that the phase impairment condition for the UE exceeds the threshold.

In some examples, the assistance information periodicity manager 850 is capable of, configured to, or operable to support a means for receiving, in association with the network entity, an assistance information transmission periodicity, where transmission of the assistance information message is in accordance with the assistance information transmission periodicity.

In some examples, the OCC scheme includes a slot-wise OCC scheme based on a phase impairment associated with the phase impairment information being below a threshold.

In some examples, the OCC scheme includes a symbol-wise OCC scheme based on a phase impairment associated with the phase impairment information being above a threshold.

In some examples, the OCC scheme includes a sub-PRB OCC scheme based on a phase impairment associated with the phase impairment information being above a threshold.

In some examples, the OCC scheme includes a symbol-wise OCC scheme, a slot-wise OCC scheme, a sub-PRB OCC scheme, or a combination thereof.

In some examples, the reference signal manager 855 is capable of, configured to, or operable to support a means for receiving, in association with the network entity, one or more reference signals. In some examples, the phase impairment information manager 845 is capable of, configured to, or operable to support a means for calculating, based on the one or more reference signals, the phase impairment information.

In some examples, the assistance information transmission manager 825 is capable of, configured to, or operable to support a means for transmitting, for the network entity after reception of the control message, a second assistance information message that indicates second phase impairment information for the UE, where the assistance information message is a first assistance information message, where the phase impairment information is a first phase impairment information, where the control message is a first control message, where the OCC configuration is a first OCC configuration, where the OCC scheme is a first OCC scheme, where the OCC factor is a first OCC factor, and where the second phase impairment information for the UE is different than the first phase impairment information. In some examples, the OCC configuration manager 830 is capable of, configured to, or operable to support a means for receiving, in association with the network entity and based on transmission of the second assistance information message, a second control message that indicates a second OCC configuration, where the second OCC configuration includes at least one of a second OCC scheme different from the first OCC scheme or a second OCC factor different from the first OCC factor.

In some examples, the phase impairment information is indicative of a phase impairment error in parts per million, a slope of change in temperature of the UE over time, or a slope of change in phase over time.

In some examples, the phase impairment information indicates a quantized state from a set of candidate quantized states. In some examples, each of the set of candidate quantized states corresponds to a range of phase impairment values.

In some examples, the uplink scheduling manager 860 is capable of, configured to, or operable to support a means for receiving, via the control message, scheduling information for the uplink shared channel communication, where transmission of the uplink shared channel communication is in accordance with the scheduling information.

In some examples, the uplink scheduling manager 860 is capable of, configured to, or operable to support a means for receiving a second control message that includes scheduling information for the uplink shared channel communication, where transmission of the uplink shared channel communication is in accordance with the scheduling information.

In some examples, the OCC configuration further includes an OCC codeword.

In some examples, the control message is conveyed via one of a DCI, RRC, or a MAC-CE.

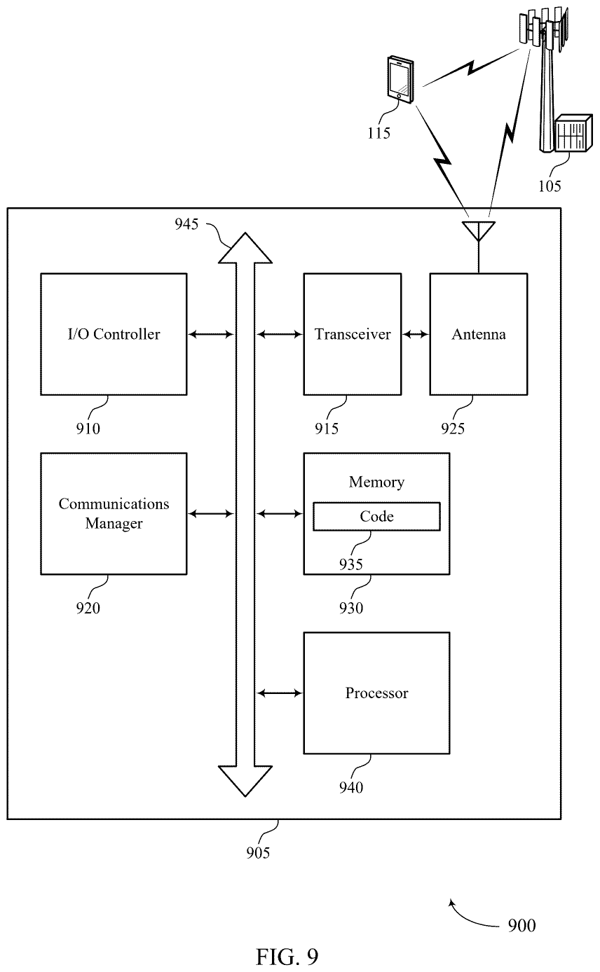

FIG. 9 shows a diagram of a system 900 including a device 905 that supports OCC configuration based on assistance information in accordance with one or more aspects of the present disclosure. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting OCC configuration based on assistance information). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The communications manager 920 may support wireless communications in accordance with examples as disclosed herein. For example, the communications manager 920 is capable of, configured to, or operable to support a means for transmitting, for a network entity, an assistance information message that indicates phase impairment information for the UE, where the phase impairment information is indicative of a change in phase over time. The communications manager 920 is capable of, configured to, or operable to support a means for receiving, in association with the network entity and based on transmission of the assistance information message, a control message that indicates an OCC configuration, where the OCC configuration includes an OCC scheme from a set of candidate OCC schemes, and where the OCC configuration includes an OCC factor. The communications manager 920 is capable of, configured to, or operable to support a means for transmitting, for the network entity, an uplink shared channel communication in accordance with the OCC configuration.

By including or configuring the communications manager 920 in accordance with examples as described herein, the device 905 may support techniques for improved communication reliability, more efficient utilization of communication resources, and improved coordination between devices.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of OCC configuration based on assistance information as described herein, or the at least one processor 940 and the at least one memory 930 may be otherwise configured to, individually or collectively, perform or support such operations.

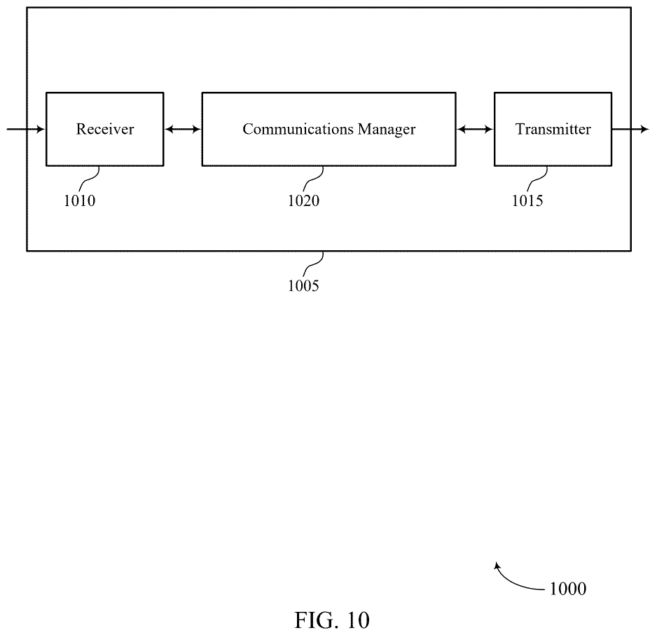

FIG. 10 shows a block diagram 1000 of a device 1005 that supports OCC configuration based on assistance information in accordance with one or more aspects of the present disclosure. The device 1005 may be an example of aspects of a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to, individually or collectively, support or enable the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations or components thereof may be examples of means for performing various aspects of OCC configuration based on assistance information as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor (e.g., referred to as a processor-executable code). If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. For example, the communications manager 1020 is capable of, configured to, or operable to support a means for obtaining an assistance information message that indicates phase impairment information for a UE, where the phase impairment information is indicative of a change in phase over time. The communications manager 1020 is capable of, configured to, or operable to support a means for outputting, for the UE and based on the assistance information message, a control message that indicates an OCC configuration, where the OCC configuration includes an OCC scheme from a set of candidate OCC schemes, and where the OCC configuration includes an OCC factor. The communications manager 1020 is capable of, configured to, or operable to support a means for obtaining an uplink shared channel communication associated with the UE in accordance with the OCC configuration.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for more efficient utilization of communication resources.

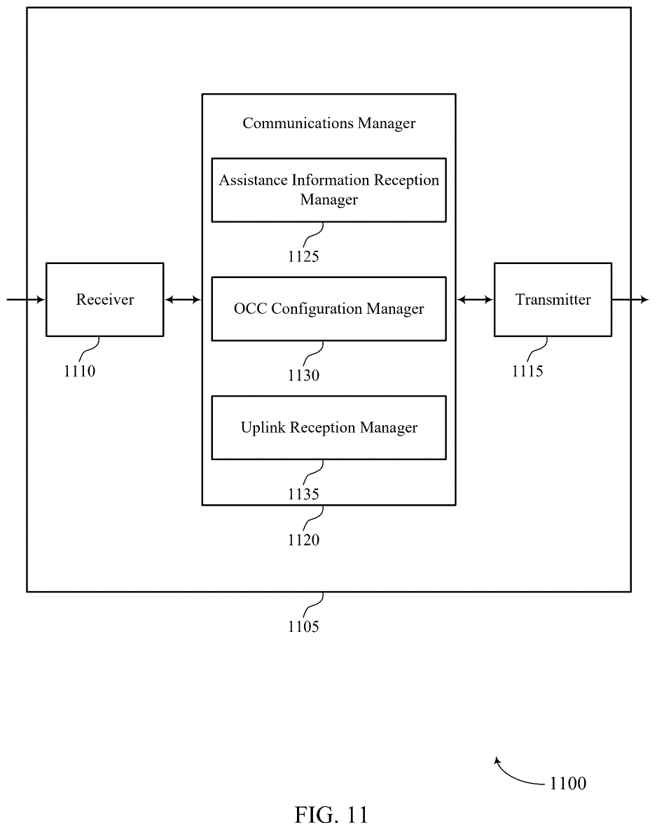

FIG. 11 shows a block diagram 1100 of a device 1105 that supports OCC configuration based on assistance information in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to support the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of OCC configuration based on assistance information as described herein. For example, the communications manager 1120 may include an assistance information reception manager 1125, a OCC configuration manager 1130, an uplink reception manager 1135, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. The assistance information reception manager 1125 is capable of, configured to, or operable to support a means for obtaining an assistance information message that indicates phase impairment information for a UE, where the phase impairment information is indicative of a change in phase over time. The OCC configuration manager 1130 is capable of, configured to, or operable to support a means for outputting, for the UE and based on the assistance information message, a control message that indicates an OCC configuration, where the OCC configuration includes an OCC scheme from a set of candidate OCC schemes, and where the OCC configuration includes an OCC factor. The uplink reception manager 1135 is capable of, configured to, or operable to support a means for obtaining an uplink shared channel communication associated with the UE in accordance with the OCC configuration.

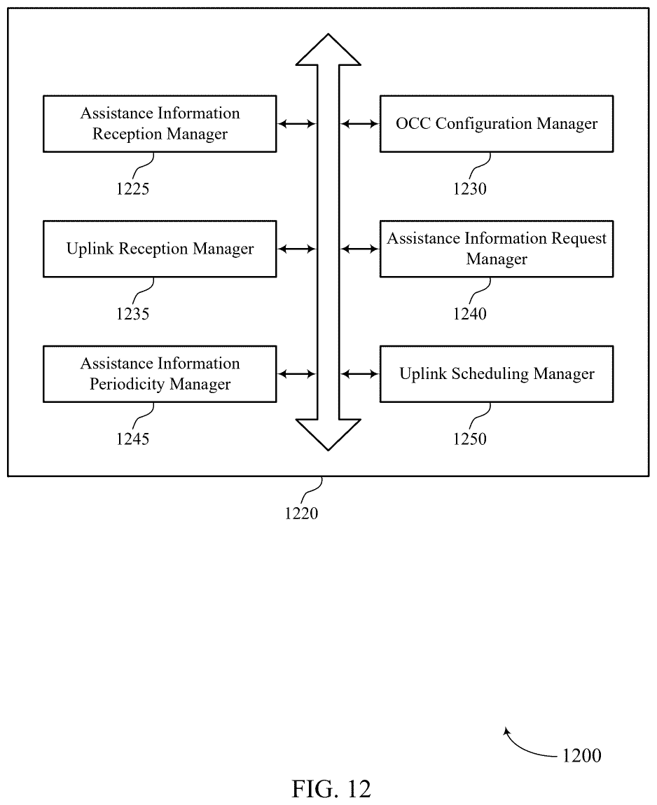

FIG. 12 shows a block diagram 1200 of a communications manager 1220 that supports OCC configuration based on assistance information in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of OCC configuration based on assistance information as described herein. For example, the communications manager 1220 may include an assistance information reception manager 1225, a OCC configuration manager 1230, an uplink reception manager 1235, an assistance information request manager 1240, an assistance information periodicity manager 1245, an uplink scheduling manager 1250, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communications in accordance with examples as disclosed herein. The assistance information reception manager 1225 is capable of, configured to, or operable to support a means for obtaining an assistance information message that indicates phase impairment information for a UE, where the phase impairment information is indicative of a change in phase over time. The OCC configuration manager 1230 is capable of, configured to, or operable to support a means for outputting, for the UE and based on the assistance information message, a control message that indicates an OCC configuration, where the OCC configuration includes an OCC scheme from a set of candidate OCC schemes, and where the OCC configuration includes an OCC factor. The uplink reception manager 1235 is capable of, configured to, or operable to support a means for obtaining an uplink shared channel communication associated with the UE in accordance with the OCC configuration.

In some examples, the assistance information reception manager 1225 is capable of, configured to, or operable to support a means for obtaining a second assistance information message that indicates second phase impairment information for a second UE, where the second phase impairment information is indicative of a second change in phase over time, where the assistance information message is a first assistance information message, where the phase impairment information is a first phase impairment information, where the UE is a first UE, where the control message is a first control message, where the OCC configuration is a first OCC configuration, and where the uplink shared channel communication is a first uplink shared channel communication. In some examples, the OCC configuration manager 1230 is capable of, configured to, or operable to support a means for outputting, for the second UE and based on the second assistance information message, a second control message that indicates a second OCC configuration, where the second OCC configuration includes the OCC scheme, where the second OCC configuration includes the OCC factor. In some examples, the uplink reception manager 1235 is capable of, configured to, or operable to support a means for obtaining, via a same set of time and frequency resources as the first uplink shared channel communication, a second uplink shared channel communication associated with the second UE in accordance with the second OCC configuration.

In some examples, the OCC configuration manager 1230 is capable of, configured to, or operable to support a means for outputting, for the first UE, an indication of a first OCC codeword associated with the first OCC configuration. In some examples, the OCC configuration manager 1230 is capable of, configured to, or operable to support a means for outputting, for the second UE, an indication of a second OCC codeword associated with the second OCC configuration, where the first uplink shared channel communication is coded in accordance with the first OCC codeword, and where the second uplink shared channel communication is coded in accordance with the second OCC codeword.

In some examples, the assistance information request manager 1240 is capable of, configured to, or operable to support a means for outputting, for the UE, a request for the assistance information message, where obtention of the assistance information message is based on the request.

In some examples, the assistance information periodicity manager 1245 is capable of, configured to, or operable to support a means for outputting, for the UE, an assistance information transmission periodicity, where obtention of the assistance information message is in accordance with the assistance information transmission periodicity.

In some examples, the OCC scheme includes a slot-wise OCC scheme based on a phase impairment associated with the phase impairment information being below a threshold.

In some examples, the OCC scheme includes a symbol-wise OCC scheme based on a phase impairment associated with the phase impairment information being above a threshold.

In some examples, the OCC scheme includes a sub-PRB OCC scheme based on a phase impairment associated with the phase impairment information being above a threshold.

In some examples, the OCC scheme includes one of a symbol-wise OCC scheme, a slot-wise OCC scheme, a sub-PRB OCC scheme, or a combination thereof.

In some examples, the assistance information reception manager 1225 is capable of, configured to, or operable to support a means for obtaining, in association with the UE and after output of the control message, a second assistance information message that indicates second phase impairment information for the UE, where the assistance information message is a first assistance information message, where the phase impairment information is a first phase impairment information, where the control message is a first control message, where the OCC configuration is a first OCC configuration, where the OCC scheme is a first OCC scheme, where the OCC factor is a first OCC factor, and where the second phase impairment information for the UE is different than the first phase impairment information. In some examples, the OCC configuration manager 1230 is capable of, configured to, or operable to support a means for outputting, for the UE and based least in part on the second assistance information message, a second control message that indicates a second OCC configuration, where the second OCC configuration includes at least one of a second OCC scheme different from the first OCC scheme or a second OCC factor different from the first OCC factor.

In some examples, the phase impairment information is indicative of a phase impairment error in parts per million, a slope of change in temperature of the UE over time, or a slope of change in phase over time.

In some examples, the phase impairment information indicates a quantized state from a set of candidate quantized states. In some examples, each of the set of candidate quantized states corresponds to a range of phase impairment values.

In some examples, the uplink scheduling manager 1250 is capable of, configured to, or operable to support a means for outputting, via the control message, scheduling information for the uplink shared channel communication, where transmission of the uplink shared channel communication is in accordance with the scheduling information.

In some examples, the uplink scheduling manager 1250 is capable of, configured to, or operable to support a means for outputting, for the UE, a second control message that includes scheduling information for the uplink shared channel communication, where transmission of the uplink shared channel communication is in accordance with the scheduling information.

In some examples, the OCC configuration further includes an OCC codeword.

In some examples, the control message is conveyed via one of a DCI, RRC, or a MAC-CE.

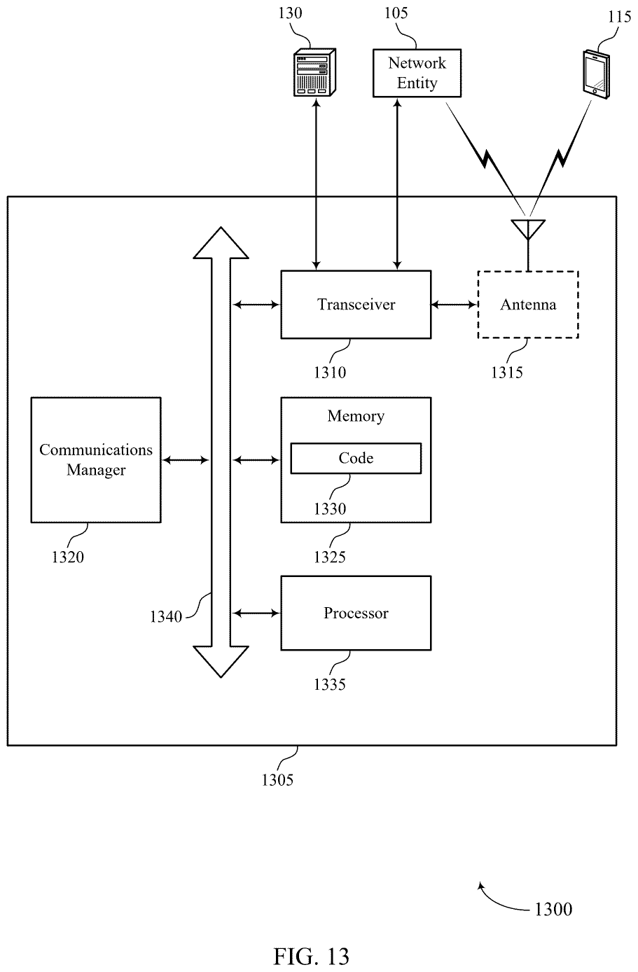

FIG. 13 shows a diagram of a system 1300 including a device 1305 that supports OCC configuration based on assistance information in accordance with one or more aspects of the present disclosure. The device 1305 may be an example of or include components of a device 1005, a device 1105, or a network entity 105 as described herein. The device 1305 may communicate with other network devices or network equipment such as one or more of the network entities 105, UEs 115, or any combination thereof. The communications may include communications over one or more wired interfaces, over one or more wireless interfaces, or any combination thereof. The device 1305 may include components that support outputting and obtaining communications, such as a communications manager 1320, a transceiver 1310, one or more antennas 1315, at least one memory 1325, code 1330, and at least one processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or one or more memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or one or more memory components (e.g., the at least one processor 1335, the at least one memory 1325, or both), may be included in a chip or chip assembly that is installed in the device 1305. In some examples, the transceiver 1310 may be operable to support communications via one or more communications links (e.g., communication link(s) 125, backhaul communication link(s) 120, a midhaul communication link 162, a fronthaul communication link 168).

The at least one memory 1325 may include RAM, ROM, or any combination thereof. The at least one memory 1325 may store computer-readable, computer-executable, or processor-executable code, such as the code 1330. The code 1330 may include instructions that, when executed by one or more of the at least one processor 1335, cause the device 1305 to perform various functions described herein. The code 1330 may be stored in a non-transitory computer-readable medium such as system memory or another type of memory. In some cases, the code 1330 may not be directly executable by a processor of the at least one processor 1335 but may cause a computer (e.g., when compiled and executed) to perform functions described herein. In some cases, the at least one memory 1325 may include, among other things, a BIOS which may control basic hardware or software operation such as the interaction with peripheral components or devices. In some examples, the at least one processor 1335 may include multiple processors and the at least one memory 1325 may include multiple memories. One or more of the multiple processors may be coupled with one or more of the multiple memories which may, individually or collectively, be configured to perform various functions herein (for example, as part of a processing system).

The at least one processor 1335 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1335 may be configured to operate a memory array using a memory controller. In some other cases, a memory controller may be integrated into one or more of the at least one processor 1335. The at least one processor 1335 may be configured to execute computer-readable instructions stored in a memory (e.g., one or more of the at least one memory 1325) to cause the device 1305 to perform various functions (e.g., functions or tasks supporting OCC configuration based on assistance information). For example, the device 1305 or a component of the device 1305 may include at least one processor 1335 and at least one memory 1325 coupled with one or more of the at least one processor 1335, the at least one processor 1335 and the at least one memory 1325 configured to perform various functions described herein. The at least one processor 1335 may be an example of a cloud-computing platform (e.g., one or more physical nodes and supporting software such as operating systems, virtual machines, or container instances) that may host the functions (e.g., by executing code 1330) to perform the functions of the device 1305. The at least one processor 1335 may be any one or more suitable processors capable of executing scripts or instructions of one or more software programs stored in the device 1305 (such as within one or more of the at least one memory 1325).

In some examples, the at least one processor 1335 may include multiple processors and the at least one memory 1325 may include multiple memories. One or more of the multiple processors may be coupled with one or more of the multiple memories, which may, individually or collectively, be configured to perform various functions herein. In some examples, the at least one processor 1335 may be a component of a processing system, which may refer to a system (such as a series) of machines, circuitry (including, for example, one or both of processor circuitry (which may include the at least one processor 1335) and memory circuitry (which may include the at least one memory 1325)), or components, that receives or obtains inputs and processes the inputs to produce, generate, or obtain a set of outputs. The processing system may be configured to perform one or more of the functions described herein. For example, the at least one processor 1335 or a processing system including the at least one processor 1335 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code stored in the at least one memory 1325 or otherwise, to perform one or more of the functions described herein.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the at least one memory 1325, the code 1330, and the at least one processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with one or more other network entities 105, and may include a controller or scheduler for controlling communications with UEs 115 (e.g., in cooperation with the one or more other network devices). In some examples, the communications manager 1320 may support an X2 interface within an LTE/LTE-A wireless communications network technology to provide communication between network entities 105.

The communications manager 1320 may support wireless communications in accordance with examples as disclosed herein. For example, the communications manager 1320 is capable of, configured to, or operable to support a means for obtaining an assistance information message that indicates phase impairment information for a UE, where the phase impairment information is indicative of a change in phase over time. The communications manager 1320 is capable of, configured to, or operable to support a means for outputting, for the UE and based on the assistance information message, a control message that indicates an OCC configuration, where the OCC configuration includes an OCC scheme from a set of candidate OCC schemes, and where the OCC configuration includes an OCC factor. The communications manager 1320 is capable of, configured to, or operable to support a means for obtaining an uplink shared channel communication associated with the UE in accordance with the OCC configuration.

By including or configuring the communications manager 1320 in accordance with examples as described herein, the device 1305 may support techniques for improved communication reliability, more efficient utilization of communication resources, and improved coordination between devices.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, one or more of the at least one processor 1335, one or more of the at least one memory 1325, the code 1330, or any combination thereof (for example, by a processing system including at least a portion of the at least one processor 1335, the at least one memory 1325, the code 1330, or any combination thereof). For example, the code 1330 may include instructions executable by one or more of the at least one processor 1335 to cause the device 1305 to perform various aspects of OCC configuration based on assistance information as described herein, or the at least one processor 1335 and the at least one memory 1325 may be otherwise configured to, individually or collectively, perform or support such operations.

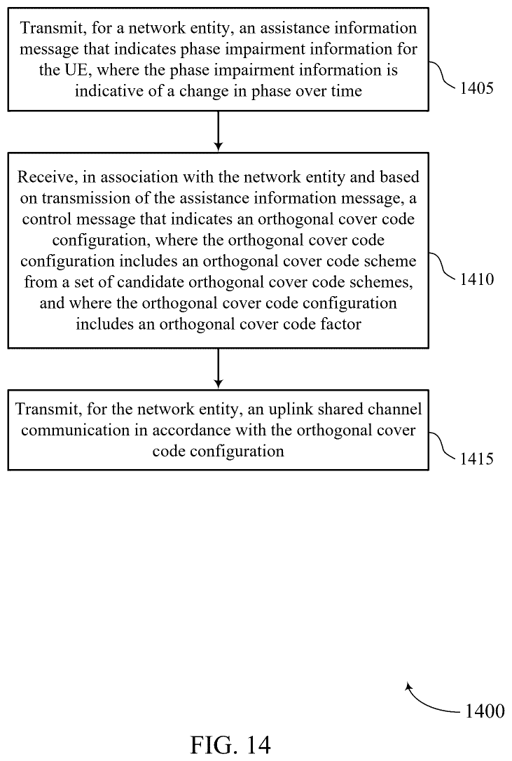

FIG. 14 shows a flowchart illustrating a method 1400 that supports OCC configuration based on assistance information in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include transmitting, for a network entity, an assistance information message that indicates phase impairment information for the UE, where the phase impairment information is indicative of a change in phase over time. The operations of 1405 may be performed in accordance with examples as disclosed herein. In some examples, aspects of the operations of 1405 may be performed by an assistance information transmission manager 825 as described with reference to FIG. 8.

At 1410, the method may include receiving, in association with the network entity and based on transmission of the assistance information message, a control message that indicates an OCC configuration, where the OCC configuration includes an OCC scheme from a set of candidate OCC schemes, and where the OCC configuration includes an OCC factor. The operations of 1410 may be performed in accordance with examples as disclosed herein. In some examples, aspects of the operations of 1410 may be performed by a OCC configuration manager 830 as described with reference to FIG. 8.

At 1415, the method may include transmitting, for the network entity, an uplink shared channel communication in accordance with the OCC configuration. The operations of 1415 may be performed in accordance with examples as disclosed herein. In some examples, aspects of the operations of 1415 may be performed by an uplink transmission manager 835 as described with reference to FIG. 8.

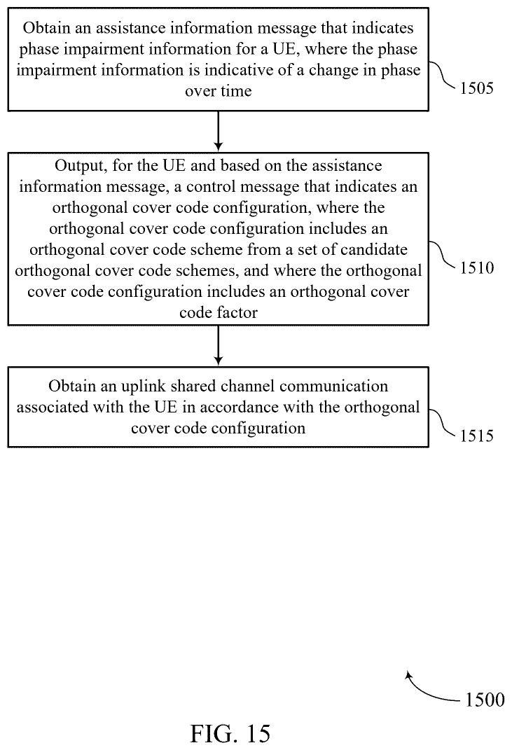

FIG. 15 shows a flowchart illustrating a method 1500 that supports OCC configuration based on assistance information in accordance with one or more aspects of the present disclosure. The operations of the method 1500 may be implemented by a network entity or its components as described herein. For example, the operations of the method 1500 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1505, the method may include obtaining an assistance information message that indicates phase impairment information for a UE, where the phase impairment information is indicative of a change in phase over time. The operations of 1505 may be performed in accordance with examples as disclosed herein. In some examples, aspects of the operations of 1505 may be performed by an assistance information reception manager 1225 as described with reference to FIG. 12.

At 1510, the method may include outputting, for the UE and based on the assistance information message, a control message that indicates an OCC configuration, where the OCC configuration includes an OCC scheme from a set of candidate OCC schemes, and where the OCC configuration includes an OCC factor. The operations of 1510 may be performed in accordance with examples as disclosed herein. In some examples, aspects of the operations of 1510 may be performed by a OCC configuration manager 1230 as described with reference to FIG. 12.

At 1515, the method may include obtaining an uplink shared channel communication associated with the UE in accordance with the OCC configuration. The operations of 1515 may be performed in accordance with examples as disclosed herein. In some examples, aspects of the operations of 1515 may be performed by an uplink reception manager 1235 as described with reference to FIG. 12.

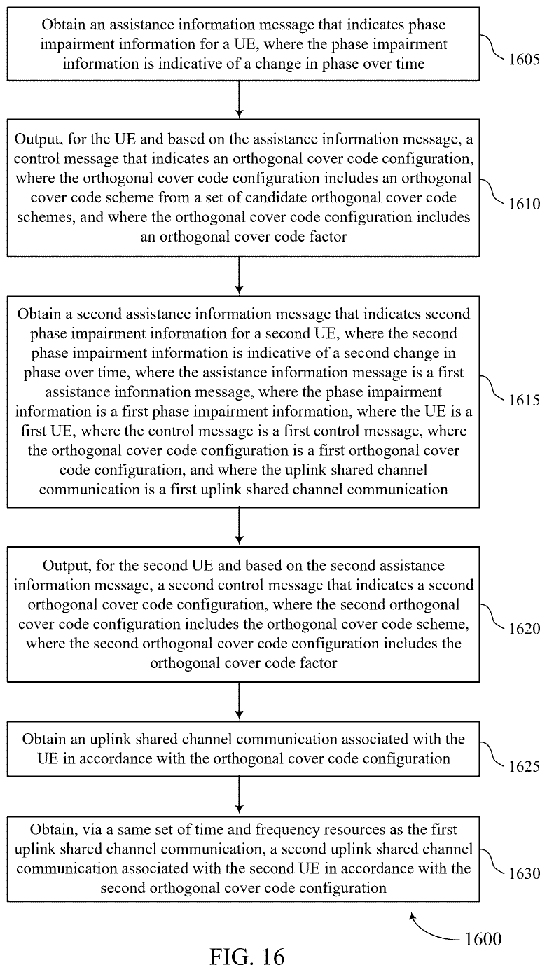

FIG. 16 shows a flowchart illustrating a method 1600 that supports OCC configuration based on assistance information in accordance with one or more aspects of the present disclosure. The operations of the method 1600 may be implemented by a network entity or its components as described herein. For example, the operations of the method 1600 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1605, the method may include obtaining an assistance information message that indicates phase impairment information for a UE, where the phase impairment information is indicative of a change in phase over time. The operations of 1605 may be performed in accordance with examples as disclosed herein. In some examples, aspects of the operations of 1605 may be performed by an assistance information reception manager 1225 as described with reference to FIG. 12.

At 1610, the method may include outputting, for the UE and based on the assistance information message, a control message that indicates an OCC configuration, where the OCC configuration includes an OCC scheme from a set of candidate OCC schemes, and where the OCC configuration includes an OCC factor. The operations of 1610 may be performed in accordance with examples as disclosed herein. In some examples, aspects of the operations of 1610 may be performed by a OCC configuration manager 1230 as described with reference to FIG. 12.

At 1615, the method may include obtaining a second assistance information message that indicates second phase impairment information for a second UE, where the second phase impairment information is indicative of a second change in phase over time, where the assistance information message is a first assistance information message, where the phase impairment information is a first phase impairment information, where the UE is a first UE, where the control message is a first control message, where the OCC configuration is a first OCC configuration, and where the uplink shared channel communication is a first uplink shared channel communication. The operations of 1615 may be performed in accordance with examples as disclosed herein. In some examples, aspects of the operations of 1615 may be performed by an assistance information reception manager 1225 as described with reference to FIG. 12.

At 1620, the method may include outputting, for the second UE and based on the second assistance information message, a second control message that indicates a second OCC configuration, where the second OCC configuration includes the OCC scheme, where the second OCC configuration includes the OCC factor. The operations of 1620 may be performed in accordance with examples as disclosed herein. In some examples, aspects of the operations of 1620 may be performed by a OCC configuration manager 1230 as described with reference to FIG. 12.

At 1625, the method may include obtaining an uplink shared channel communication associated with the UE in accordance with the OCC configuration. The operations of 1625 may be performed in accordance with examples as disclosed herein. In some examples, aspects of the operations of 1625 may be performed by an uplink reception manager 1235 as described with reference to FIG. 12.

At 1630, the method may include obtaining, via a same set of time and frequency resources as the first uplink shared channel communication, a second uplink shared channel communication associated with the second UE in accordance with the second OCC configuration. The operations of 1630 may be performed in accordance with examples as disclosed herein. In some examples, aspects of the operations of 1630 may be performed by an uplink reception manager 1235 as described with reference to FIG. 12.

The following provides an overview of aspects of the present disclosure:

Aspect 1: A method for wireless communications at a UE, comprising: transmitting, for a network entity, an assistance information message that indicates phase impairment information for the UE, wherein the phase impairment information is indicative of a change in phase over time; receiving, in association with the network entity and based at least in part on transmission of the assistance information message, a control message that indicates an OCC configuration, wherein the OCC configuration comprises an OCC scheme from a set of candidate OCC schemes, and wherein the OCC configuration comprises an OCC factor; and transmitting, for the network entity, an uplink shared channel communication in accordance with the OCC configuration.

Aspect 2: The method of aspect 1, further comprising: receiving, from the network entity, a request for the assistance information message, wherein transmission of the assistance information message is based at least in part on the request.

Aspect 3: The method of aspect 2, further comprising: resetting an assistance information timer based at least in part on reception of the request, wherein the assistance information timer is associated with triggering transmission of the assistance information message.

Aspect 4: The method of any of aspects 1 through 3, wherein transmission of the assistance information message is based at least in part on an expiration of an assistance information timer associated with triggering transmission of the assistance information message.

Aspect 5: The method of any of aspects 1 through 4, further comprising: detecting that a phase impairment condition for the UE exceeds a threshold, wherein transmission of the assistance information message is based at least in part on detection that the phase impairment condition for the UE exceeds the threshold.

Aspect 6: The method of any of aspects 1 through 5, further comprising: receiving, in association with the network entity, an assistance information transmission periodicity, wherein transmission of the assistance information message is in accordance with the assistance information transmission periodicity.

Aspect 7: The method of any of aspects 1 through 6, wherein the OCC scheme comprises a slot-wise OCC scheme based at least in part on a phase impairment associated with the phase impairment information being below a threshold.

Aspect 8: The method of any of aspects 1 through 6, wherein the OCC scheme comprises a symbol-wise OCC scheme based at least in part on a phase impairment associated with the phase impairment information being above a threshold.

Aspect 9: The method of any of aspects 1 through 6, wherein the OCC scheme comprises a sub-PRB OCC scheme based at least in part on a phase impairment associated with the phase impairment information being above a threshold.

Aspect 10: The method of any of aspects 1 through 6, wherein the OCC scheme comprises a symbol-wise OCC scheme, a slot-wise OCC scheme, a sub-PRB OCC scheme, or a combination thereof.

Aspect 11: The method of any of aspects 1 through 10, further comprising: receiving, in association with the network entity, one or more reference signals; and calculating, based at least in part on the one or more reference signals, the phase impairment information.

Aspect 12: The method of any of aspects 1 through 11, further comprising: transmitting, for the network entity after reception of the control message, a second assistance information message that indicates second phase impairment information for the UE, wherein the assistance information message is a first assistance information message, wherein the phase impairment information is a first phase impairment information, wherein the control message is a first control message, wherein the OCC configuration is a first OCC configuration, wherein the OCC scheme is a first OCC scheme, wherein the OCC factor is a first OCC factor, and wherein the second phase impairment information for the UE is different than the first phase impairment information; and receiving, in association with the network entity and based at least in part on transmission of the second assistance information message, a second control message that indicates a second OCC configuration, wherein the second OCC configuration comprises at least one of a second OCC scheme different from the first OCC scheme or a second OCC factor different from the first OCC factor.

Aspect 13: The method of any of aspects 1 through 12, wherein the phase impairment information is indicative of a phase impairment error in parts per million, a slope of change in temperature of the UE over time, or a slope of change in phase over time.

Aspect 14: The method of any of aspects 1 through 13, wherein the phase impairment information indicates a quantized state from a set of candidate quantized states, and each of the set of candidate quantized states corresponds to a range of phase impairment values.

Aspect 15: The method of any of aspects 1 through 14, further comprising: receiving, via the control message, scheduling information for the uplink shared channel communication, wherein transmission of the uplink shared channel communication is in accordance with the scheduling information.

Aspect 16: The method of any of aspects 1 through 14, further comprising: receiving a second control message that comprises scheduling information for the uplink shared channel communication, wherein transmission of the uplink shared channel communication is in accordance with the scheduling information.

Aspect 17: The method of any of aspects 1 through 16, wherein the OCC configuration further comprises an OCC codeword.

Aspect 18: The method of any of aspects 1 through 17, wherein the control message is conveyed via one of a downlink control information, radio resource control, or a MAC-CE.

Aspect 19: A method for wireless communications at a network entity, comprising: obtaining an assistance information message that indicates phase impairment information for a UE, wherein the phase impairment information is indicative of a change in phase over time; outputting, for the UE and based at least in part on the assistance information message, a control message that indicates an OCC configuration, wherein the OCC configuration comprises an OCC scheme from a set of candidate OCC schemes, and wherein the OCC configuration comprises an OCC factor; and obtaining an uplink shared channel communication associated with the UE in accordance with the OCC configuration.

Aspect 20: The method of aspect 19, further comprising: obtaining a second assistance information message that indicates second phase impairment information for a second UE, wherein the second phase impairment information is indicative of a second change in phase over time, wherein the assistance information message is a first assistance information message, wherein the phase impairment information is a first phase impairment information, wherein the UE is a first UE, wherein the control message is a first control message, wherein the OCC configuration is a first OCC configuration, and wherein the uplink shared channel communication is a first uplink shared channel communication; outputting, for the second UE and based at least in part on the second assistance information message, a second control message that indicates a second OCC configuration, wherein the second OCC configuration comprises the OCC scheme, wherein the second OCC configuration comprises the OCC factor; and obtaining, via a same set of time and frequency resources as the first uplink shared channel communication, a second uplink shared channel communication associated with the second UE in accordance with the second OCC configuration.

Aspect 21: The method of aspect 20, further comprising: outputting, for the first UE, an indication of a first OCC codeword associated with the first OCC configuration; and outputting, for the second UE, an indication of a second OCC codeword associated with the second OCC configuration, wherein the first uplink shared channel communication is coded in accordance with the first OCC codeword, and wherein the second uplink shared channel communication is coded in accordance with the second OCC codeword.

Aspect 22: The method of any of aspects 19 through 21, further comprising: outputting, for the UE, a request for the assistance information message, wherein obtention of the assistance information message is based at least in part on the request.

Aspect 23: The method of any of aspects 19 through 22, further comprising: outputting, for the UE, an assistance information transmission periodicity, wherein obtention of the assistance information message is in accordance with the assistance information transmission periodicity.

Aspect 24: The method of any of aspects 19 through 23, wherein the OCC scheme comprises a slot-wise OCC scheme based at least in part on a phase impairment associated with the phase impairment information being below a threshold.

Aspect 25: The method of any of aspects 19 through 23, wherein the OCC scheme comprises a symbol-wise OCC scheme based at least in part on a phase impairment associated with the phase impairment information being above a threshold.

Aspect 26: The method of any of aspects 19 through 23, wherein the OCC scheme comprises a sub-PRB OCC scheme based at least in part on a phase impairment associated with the phase impairment information being above a threshold.

Aspect 27: The method of any of aspects 19 through 23, wherein the OCC scheme comprises a symbol-wise OCC scheme, a slot-wise OCC scheme, a sub-PRB OCC scheme, or a combination thereof.

Aspect 28: The method of any of aspects 19 through 27, further comprising: obtaining, in association with the UE and after output of the control message, a second assistance information message that indicates second phase impairment information for the UE, wherein the assistance information message is a first assistance information message, wherein the phase impairment information is a first phase impairment information, wherein the control message is a first control message, wherein the OCC configuration is a first OCC configuration, wherein the OCC scheme is a first OCC scheme, wherein the OCC factor is a first OCC factor, and wherein the second phase impairment information for the UE different than the first phase impairment information; and outputting, for the UE and based least in part on the second assistance information message, a second control message that indicates a second OCC configuration, wherein the second OCC configuration comprises at least one of a second OCC scheme different from the first OCC scheme or a second OCC factor different from the first OCC factor.

Aspect 29: The method of any of aspects 19 through 28, wherein the phase impairment information is indicative of a phase impairment error in parts per million, a slope of change in temperature of the UE over time, or a slope of change in phase over time.

Aspect 30: The method of any of aspects 19 through 29, wherein the phase impairment information indicates a quantized state from a set of candidate quantized states, and each of the set of candidate quantized states corresponds to a range of phase impairment values.

Aspect 31: The method of any of aspects 19 through 30, further comprising: outputting, via the control message, scheduling information for the uplink shared channel communication, wherein transmission of the uplink shared channel communication is in accordance with the scheduling information.

Aspect 32: The method of any of aspects 19 through 30, further comprising: outputting, for the UE, a second control message that comprises scheduling information for the uplink shared channel communication, wherein transmission of the uplink shared channel communication is in accordance with the scheduling information.

Aspect 33: The method of any of aspects 19 through 32, wherein the OCC configuration further comprises an OCC codeword.

Aspect 34: The method of any of aspects 19 through 33, wherein the control message is conveyed via one of a downlink control information, radio resource control, or a MAC-CE.

Aspect 35: An apparatus for wireless communication at UE, comprising: one or more memories storing processor-executable code; and one or more processors coupled with the one or more memories and configured to cause the UE to perform a method of any of aspects 1 through 18.

Aspect 36: A UE for wireless communications, comprising at least one means for performing a method of any of aspects 1 through 18.

Aspect 37: A non-transitory computer-readable medium storing code for wireless communications, the code comprising instructions executable by one or more processors to cause a UE to perform a method of any of aspects 1 through 18.

Aspect 38: An apparatus for wireless communication at network entity, comprising: one or more memories storing processor-executable code; and one or more processors coupled with the one or more memories and configured to cause the network entity to perform a method of any of aspects 19 through 34.

Aspect 39: A network entity for wireless communications, comprising at least one means for performing a method of any of aspects 19 through 34.

Aspect 40: A non-transitory computer-readable medium storing code for wireless communications, the code comprising instructions executable by one or more processors to cause a network entity to perform a method of any of aspects 19 through 34.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at user equipment (UE), comprising:
one or more memories storing processor-executable code; and
one or more processors coupled with the one or more memories and configured to cause the UE to:
transmit, for a network entity, an assistance information message that indicates phase impairment information for the UE, wherein the phase impairment information is indicative of a change in phase over time;
receive, in association with the network entity and based at least in part on transmission of the assistance information message, a control message that indicates an orthogonal cover code configuration, wherein the orthogonal cover code configuration comprises an orthogonal cover code scheme from a set of candidate orthogonal cover code schemes, and wherein the orthogonal cover code configuration comprises an orthogonal cover code factor; and
transmit, for the network entity, an uplink shared channel communication in accordance with the orthogonal cover code configuration.

2. The apparatus of claim 1, wherein the one or more processors are further configured to cause the UE to:
receive, from the network entity, a request for the assistance information message, wherein transmission of the assistance information message is based at least in part on the request.

3. The apparatus of claim 2, wherein the one or more processors are further configured to cause the UE to:
reset an assistance information timer based at least in part on reception of the request, wherein the assistance information timer is associated with trigger of transmission of the assistance information message.

4. The apparatus of claim 1, wherein transmission of the assistance information message is based at least in part on an expiration of an assistance information timer associated with trigger of transmission of the assistance information message.

5. The apparatus of claim 1, wherein the one or more processors are further configured to cause the UE to:
detect that a phase impairment condition for the UE exceeds a threshold, wherein transmission of the assistance information message is based at least in part on detection that the phase impairment condition for the UE exceeds the threshold.

6. The apparatus of claim 1, wherein the one or more processors are further configured to cause the UE to:
receive, in association with the network entity, an assistance information transmission periodicity, wherein transmission of the assistance information message is in accordance with the assistance information transmission periodicity.

7. The apparatus of claim 1, wherein the orthogonal cover code scheme comprises a slot-wise orthogonal cover code scheme based at least in part on a phase impairment associated with the phase impairment information below a threshold.

8. The apparatus of claim 1, wherein the orthogonal cover code scheme comprises a symbol-wise orthogonal cover code scheme based at least in part on a phase impairment associated with the phase impairment information above a threshold.

9. The apparatus of claim 1, wherein the orthogonal cover code scheme comprises a sub-physical resource block orthogonal cover code scheme based at least in part on a phase impairment associated with the phase impairment information above a threshold.

10. The apparatus of claim 1, wherein the orthogonal cover code scheme comprises a symbol-wise orthogonal cover code scheme, a slot-wise orthogonal cover code scheme, a sub-physical resource block orthogonal cover code scheme, or a combination thereof.

11. The apparatus of claim 1, further comprising an antenna, wherein the one or more processors are further configured to cause the UE to:
receive, via the antenna and in association with the network entity, one or more reference signals; and
calculate, based at least in part on the one or more reference signals, the phase impairment information.

12. The apparatus of claim 1, wherein the one or more processors are further configured to cause the UE to:
transmit, for the network entity after reception of the control message, a second assistance information message that indicates second phase impairment information for the UE, wherein the assistance information message is a first assistance information message, wherein the phase impairment information is a first phase impairment information, wherein the control message is a first control message, wherein the orthogonal cover code configuration is a first orthogonal cover code configuration, wherein the orthogonal cover code scheme is a first orthogonal cover code scheme, wherein the orthogonal cover code factor is a first orthogonal cover code factor, and wherein the second phase impairment information for the UE is different than the first phase impairment information; and
receive, in association with the network entity and based at least in part on transmission of the second assistance information message, a second control message that indicates a second orthogonal cover code configuration, wherein the second orthogonal cover code configuration comprises at least one of a second orthogonal cover code scheme different from the first orthogonal cover code scheme or a second orthogonal cover code factor different from the first orthogonal cover code factor.

13. The apparatus of claim 1, wherein the phase impairment information is indicative of a phase impairment error in parts per million, a slope of change in temperature of the UE over time, or a slope of change in phase over time.

14. The apparatus of claim 1, wherein:
the phase impairment information indicates a quantized state from a set of candidate quantized states, and
each of the set of candidate quantized states corresponds to a range of phase impairment values.

15. The apparatus of claim 1, wherein the one or more processors are further configured to cause the UE to:
receive, via the control message, scheduling information for the uplink shared channel communication, wherein transmission of the uplink shared channel communication is in accordance with the scheduling information.

16. The apparatus of claim 1, wherein the one or more processors are further configured to cause the UE to:
receive a second control message that comprises scheduling information for the uplink shared channel communication, wherein transmission of the uplink shared channel communication is in accordance with the scheduling information.

17. The apparatus of claim 1, wherein the orthogonal cover code configuration further comprises an orthogonal cover code codeword.

18. The apparatus of claim 1, wherein the control message is conveyed via one of a downlink control information, radio resource control, or a medium access control (MAC) control element.

19. An apparatus for wireless communication at network entity, comprising:
one or more memories storing processor-executable code; and
one or more processors coupled with the one or more memories and configured to cause the network entity to:
obtain an assistance information message that indicates phase impairment information for a user equipment (UE), wherein the phase impairment information is indicative of a change in phase over time;
output, for the UE and based at least in part on the assistance information message, a control message that indicates an orthogonal cover code configuration, wherein the orthogonal cover code configuration comprises an orthogonal cover code scheme from a set of candidate orthogonal cover code schemes, and wherein the orthogonal cover code configuration comprises an orthogonal cover code factor; and
obtain an uplink shared channel communication associated with the UE in accordance with the orthogonal cover code configuration.

20. The apparatus of claim 19, wherein the one or more processors are further configured to cause the network entity to:
obtain a second assistance information message that indicates second phase impairment information for a second UE, wherein the second phase impairment information is indicative of a second change in phase over time, wherein the assistance information message is a first assistance information message, wherein the phase impairment information is a first phase impairment information, wherein the UE is a first UE, wherein the control message is a first control message, wherein the orthogonal cover code configuration is a first orthogonal cover code configuration, and wherein the uplink shared channel communication is a first uplink shared channel communication;
output, for the second UE and based at least in part on the second assistance information message, a second control message that indicates a second orthogonal cover code configuration, wherein the second orthogonal cover code configuration comprises the orthogonal cover code scheme, wherein the second orthogonal cover code configuration comprises the orthogonal cover code factor; and
obtain, via a same set of time and frequency resources as the first uplink shared channel communication, a second uplink shared channel communication associated with the second UE in accordance with the second orthogonal cover code configuration.

21. The apparatus of claim 20, wherein the one or more processors are further configured to cause the network entity to:
output, for the first UE, an indication of a first orthogonal cover code codeword associated with the first orthogonal cover code configuration; and
output, for the second UE, an indication of a second orthogonal cover code codeword associated with the second orthogonal cover code configuration, wherein the first uplink shared channel communication is coded in accordance with the first orthogonal cover code codeword, and wherein the second uplink shared channel communication is coded in accordance with the second orthogonal cover code codeword.

22. The apparatus of claim 19, wherein the one or more processors are further configured to cause the network entity to:
output, for the UE, a request for the assistance information message, wherein obtention of the assistance information message is based at least in part on the request.

23. The apparatus of claim 19, wherein the one or more processors are further configured to cause the network entity to:
output, for the UE, an assistance information transmission periodicity, wherein obtention of the assistance information message is in accordance with the assistance information transmission periodicity.

24. The apparatus of claim 19, wherein the orthogonal cover code scheme comprises a slot-wise orthogonal cover code scheme based at least in part on a phase impairment associated with the phase impairment information below a threshold.

25. The apparatus of claim 19, wherein the orthogonal cover code scheme comprises a symbol-wise orthogonal cover code scheme based at least in part on a phase impairment associated with the phase impairment information above a threshold.

26. The apparatus of claim 19, wherein the orthogonal cover code scheme comprises a sub-physical resource block orthogonal cover code scheme based at least in part on a phase impairment associated with the phase impairment information above a threshold.

27. The apparatus of claim 19, wherein the orthogonal cover code scheme comprises a symbol-wise orthogonal cover code scheme, a slot-wise orthogonal cover code scheme, a sub-physical resource block orthogonal cover code scheme, or a combination thereof.

28. The apparatus of claim 19, wherein the one or more processors are further configured to cause the network entity to:
obtain, in association with the UE and after output of the control message, a second assistance information message that indicates second phase impairment information for the UE, wherein the assistance information message is a first assistance information message, wherein the phase impairment information is a first phase impairment information, wherein the control message is a first control message, wherein the orthogonal cover code configuration is a first orthogonal cover code configuration, wherein the orthogonal cover code scheme is a first orthogonal cover code scheme, wherein the orthogonal cover code factor is a first orthogonal cover code factor, and wherein the second phase impairment information for the UE is different than the first phase impairment information; and
output, for the UE and based least in part on the second assistance information message, a second control message that indicates a second orthogonal cover code configuration, wherein the second orthogonal cover code configuration comprises at least one of a second orthogonal cover code scheme different from the first orthogonal cover code scheme or a second orthogonal cover code factor different from the first orthogonal cover code factor.

29. A method for wireless communications at a user equipment (UE), comprising:
transmitting, for a network entity, an assistance information message that indicates phase impairment information for the UE, wherein the phase impairment information is indicative of a change in phase over time;
receiving, in association with the network entity and based at least in part on transmission of the assistance information message, a control message that indicates an orthogonal cover code configuration, wherein the orthogonal cover code configuration comprises an orthogonal cover code scheme from a set of candidate orthogonal cover code schemes, and wherein the orthogonal cover code configuration comprises an orthogonal cover code factor; and
transmitting, for the network entity, an uplink shared channel communication in accordance with the orthogonal cover code configuration.

30. A method for wireless communications at a network entity, comprising:
obtaining an assistance information message that indicates phase impairment information for a user equipment (UE), wherein the phase impairment information is indicative of a change in phase over time;
outputting, for the UE and based at least in part on the assistance information message, a control message that indicates an orthogonal cover code configuration, wherein the orthogonal cover code configuration comprises an orthogonal cover code scheme from a set of candidate orthogonal cover code schemes, and wherein the orthogonal cover code configuration comprises an orthogonal cover code factor; and
obtaining an uplink shared channel communication associated with the UE in accordance with the orthogonal cover code configuration.
